(19) United States
(12) Patent Application Publication
(10) Pub. No.: US 2016/0042271 A1
(43) Pub. Date: Feb. 11, 2016

(54) ARTIFICIAL NEURONS AND SPIKING NEURONS WITH ASYNCHRONOUS PULSE MODULATION

(71) Applicant: QUALCOMM Incorporated, San Diego, CA (US)

(72) Inventors: Young Cheul YOON, San Diego, CA (US); Vladimir APARIN, San Diego, CA (US)

(21) Appl. No.: 14/522,348

(22) Filed: Oct. 23, 2014

Related U.S. Application Data
(60) Provisional application No. 62/035,192, filed on Aug. 8, 2014.

(51) Int. Cl. G06N 3/08; G06N 3/04

(52) U.S. Cl. CPC G06N 3/08; G06N 3/04

(57) ABSTRACT

A method for configuring an artificial neuron includes receiving a set of input spike trains comprising asynchronous pulse modulation coding representations. The method also includes generating output spikes representing a similarity between the set of input spike trains and a spatial-temporal filter.

### CROSS-REFERENCE TO RELATED APPLICATION

The present application claims the benefit of U.S. Provisional Patent Application No. 62/035,192, filed on Aug. 8, 2014, and titled “ARTIFICIAL NEURONS AND SPIKING NEURONS WITH ASYNCHRONOUS PULSE MODULATION,” the disclosure of which is expressly incorporated by reference herein in its entirety.

### BACKGROUND

1. Field

Certain aspects of the present disclosure generally relate to neural system engineering and, more particularly, to systems and methods for configuring artificial neurons and/or spiking neurons with asynchronous pulse modulation.

2. Background

An artificial neural network, which may comprise an interconnected group of artificial neurons (i.e., neuron models), is a computational device or represents a method to be performed by a computational device. Artificial neural networks may have corresponding structure and/or function in biological neural networks. However, artificial neural networks may provide innovative and useful computational techniques for certain applications in which traditional computational techniques are cumbersome, impractical, or inadequate. Because artificial neural networks can infer a function from observations, such networks are particularly useful in applications where the complexity of the task or data makes the design of the function by conventional techniques burdensome.

### SUMMARY

In an aspect of the present disclosure, a method for configuring an artificial neuron is presented. The method includes receiving a set of input spike trains comprising asynchronous pulse modulation coding representations. The method also includes generating output spikes representing a similarity between the set of input spike trains and a spatial-temporal filter.

In another aspect of the present disclosure, an apparatus for configuring an artificial neuron is presented. The apparatus includes a memory and one or more processors coupled to the memory. The processor(s) is(are) configured to receive a set of input spike trains comprising asynchronous pulse modulation coding representations. The processor(s) is(are) also configured to generate output spikes representing a similarity between the set of input spike trains and a spatial-temporal filter.

In yet another aspect of the present disclosure, an apparatus for configuring an artificial neuron is presented. The apparatus includes means for receiving a set of input spike trains comprising asynchronous pulse modulation coding representations. The apparatus also includes means for generating output spikes representing a similarity between the set of input spike trains and a spatial-temporal filter.

In still another aspect of the present disclosure, a computer program product for configuring an artificial neuron is presented. The computer program product includes a non-transitory computer readable medium having encoded thereon program code. The program code includes program code to receive a set of input spike trains comprising asynchronous pulse modulation coding representations. The program code also includes program code to generate output spikes representing a similarity between the set of input spike trains and a spatial-temporal filter.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example network of neurons in accordance with certain aspects of the present disclosure.

FIG. 2 illustrates an example of a processing unit (neuron) of a computational network (neural system or neural network) in accordance with certain aspects of the present disclosure.

FIG. 3 illustrates an example of spike-timing dependent plasticity (STDP) curve in accordance with certain aspects of the present disclosure.

FIG. 4 illustrates an example of a positive regime and a negative regime for defining behavior of a neuron model in accordance with certain aspects of the present disclosure.

FIG. 5 illustrates an example implementation of designing a neural network using a general-purpose processor in accordance with certain aspects of the present disclosure.

FIG. 6 illustrates an example implementation of designing a neural network where a memory may be interfaced with individual distributed processing units in accordance with certain aspects of the present disclosure.

FIG. 7 illustrates an example implementation of designing a neural network based on distributed memories and distributed processing units in accordance with certain aspects of the present disclosure.

FIG. 8 illustrates an example implementation of a neural network in accordance with certain aspects of the present disclosure.

FIG. 9 is a block diagram illustrating an exemplary encoder/decoder pair in accordance with certain aspects of the present disclosure.

FIG. 10 is a block diagram illustrating an exemplary artificial neuron configured as a spatial processor in accordance with certain aspects of the present disclosure.

FIGS. 11, 12A and 12B are block diagrams illustrating an exemplary simplified artificial neuron in accordance with certain aspects of the present disclosure.

FIG. 13 is a block diagram illustrating an exemplary artificial neuron configured as a spatial-temporal processor in accordance with certain aspects of the present disclosure.

FIG. 14 is a block diagram illustrating an exemplary simplified artificial neuron configured as a spatial processor in accordance with certain aspects of the present disclosure.

FIG. 15 is a block diagram illustrating an exemplary artificial neuron configured as a temporal processor in accordance with certain aspects of the present disclosure.

FIG. 16 is flow diagram illustrating a method for configuring an artificial neuron in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System, Training and Operation

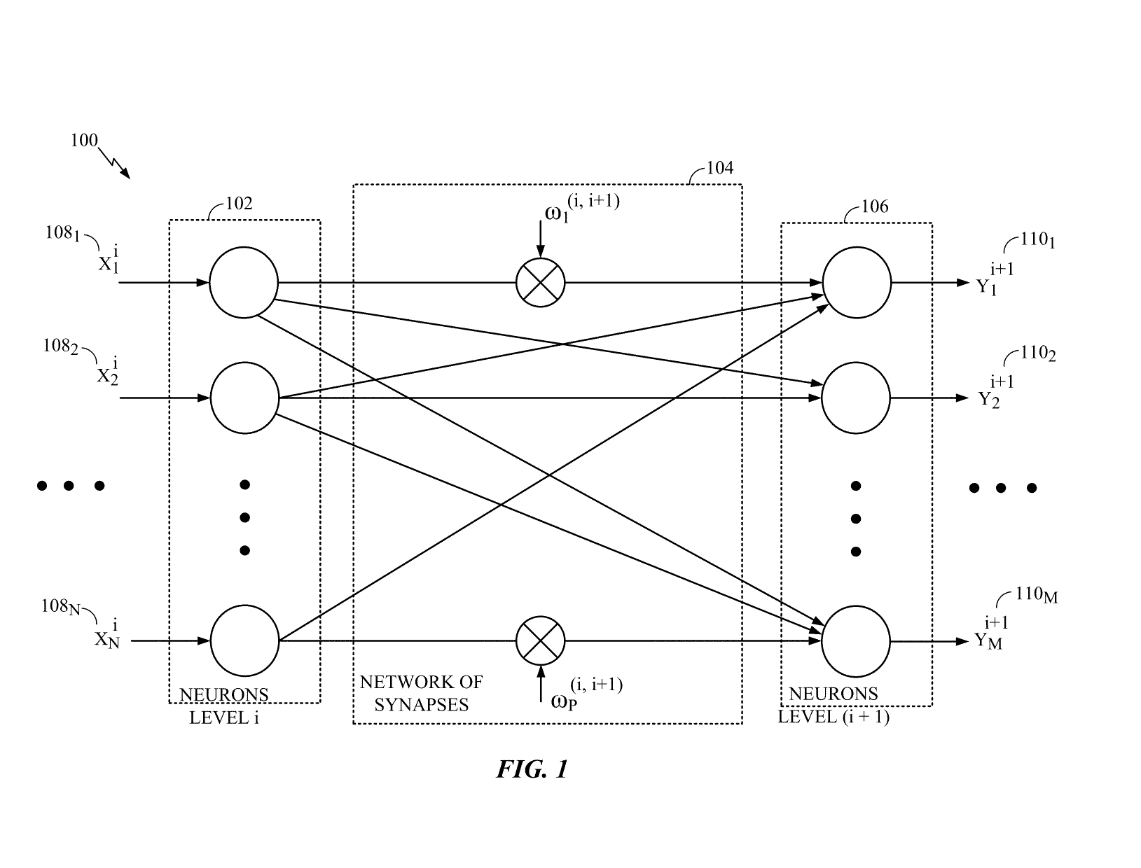

FIG. 1 illustrates an example artificial neural system 100 with multiple levels of neurons in accordance with certain aspects of the present disclosure. The neural system 100 may have a level of neurons 102 connected to another level of neurons 106 through a network of synaptic connections 104 (i.e., feed-forward connections). For simplicity, only two levels of neurons are illustrated in FIG. 1, although fewer or more levels of neurons may exist in a neural system. It should be noted that some of the neurons may connect to other neurons of the same layer through lateral connections. Furthermore, some of the neurons may connect back to a neuron of a previous layer through feedback connections.

As illustrated in FIG. 1, each neuron in the level 102 may receive an input signal 108 that may be generated by neurons of a previous level (not shown in FIG. 1). The signal 108 may represent an input current of the level 102 neuron. This current may be accumulated on the neuron membrane to charge a membrane potential. When the membrane potential reaches its threshold value, the neuron may fire and generate an output spike to be transferred to the next level of neurons (e.g., the level 106). In some modeling approaches, the neuron may continuously transfer a signal to the next level of neurons. This signal is typically a function of the membrane potential. Such behavior can be emulated or simulated in hardware and/or software, including analog and digital implementations such as those described below.

In biological neurons, the output spike generated when a neuron fires is referred to as an action potential. This electrical signal is a relatively rapid, transient, nerve impulse, having an amplitude of roughly 100 mV and a duration of about 1 ms. In a particular embodiment of a neural system having a series of connected neurons (e.g., the transfer of spikes from one level of neurons to another in FIG. 1), every action potential has basically the same amplitude and duration, and thus, the information in the signal may be represented only by the frequency and number of spikes, or the time of spikes, rather than by the amplitude. The information carried by an action potential may be determined by the spike, the neuron that spiked, and the time of the spike relative to other spike or spikes. The importance of the spike may be determined by a weight applied to a connection between neurons, as explained below.

The transfer of spikes from one level of neurons to another may be achieved through the network of synaptic connections (or simply “synapses”) 104, as illustrated in FIG. 1. Relative to the synapses 104, neurons of level 102 may be considered presynaptic neurons and neurons of level 106 may be considered postsynaptic neurons. The synapses 104 may receive output signals (i.e., spikes) from the level 102 neurons and scale those signals according to adjustable synaptic weights w₁^{(i,i+1)}, . . . , w_{P}^{(i,i+1)} where P is a total number of synaptic connections between the neurons of levels 102 and 106 and i is an indicator of the neuron level. In the example of FIG. 1, i represents neuron level 102 and i+1 represents neuron level 106. Further, the scaled signals may be combined as an input signal of each neuron in the level 106. Every neuron in the level 106 may generate output spikes 110 based on the corresponding combined input signal. The output spikes 110 may be transferred to another level of neurons using another network of synaptic connections (not shown in FIG. 1).

Biological synapses can mediate either excitatory or inhibitory (hyperpolarizing) actions in postsynaptic neurons and can also serve to amplify neuronal signals. Excitatory signals depolarize the membrane potential (i.e., increase the membrane potential with respect to the resting potential). If enough excitatory signals are received within a certain time period to depolarize the membrane potential above a threshold, an action potential occurs in the postsynaptic neuron. In contrast, inhibitory signals generally hyperpolarize (i.e., lower) the membrane potential. Inhibitory signals, if strong enough, can counteract the sum of excitatory signals and prevent the membrane potential from reaching a threshold. In addition to counteracting synaptic excitation, synaptic inhibition can exert powerful control over spontaneously active neurons. A spontaneously active neuron refers to a neuron that spikes without further input, for example due to its dynamics or a feedback. By suppressing the spontaneous generation of action potentials in these neurons, synaptic inhibition can shape the pattern of firing in a neuron, which is generally referred to as sculpturing. The various synapses 104 may act as any combination of excitatory or inhibitory synapses, depending on the behavior desired.

The neural system 100 may be emulated by a general purpose processor, a digital signal processor (DSP), an application specific integrated circuit (ASIC), a field programmable gate array (FPGA) or other programmable logic device (PLD), discrete gate or transistor logic, discrete hardware components, a software module executed by a processor, or any combination thereof. The neural system 100 may be utilized in a large range of applications, such as image and pattern recognition, machine learning, motor control, and alike. Each neuron in the neural system 100 may be implemented as a neuron circuit. The neuron membrane charged to the threshold value initiating the output spike may be implemented, for example, as a capacitor that integrates an electrical current flowing through it.

In an aspect, the capacitor may be eliminated as the electrical current integrating device of the neuron circuit, and a smaller memristor element may be used in its place. This approach may be applied in neuron circuits, as well as in various other applications where bulky capacitors are utilized as electrical current integrators. In addition, each of the synapses 104 may be implemented based on a memristor element, where synaptic weight changes may relate to changes of the memristor resistance. With nanometer feature-sized memristors, the area of a neuron circuit and synapses may be substantially reduced, which may make implementation of a large-scale neural system hardware implementation more practical.

Functionality of a neural processor that emulates the neural system 100 may depend on weights of synaptic connections, which may control strengths of connections between neurons. The synaptic weights may be stored in a non-volatile memory in order to preserve functionality of the processor after being powered down. In an aspect, the synaptic weight memory may be implemented on a separate external chip from the main neural processor chip. The synaptic weight memory may be packaged separately from the neural processor chip as a replaceable memory card. This may provide diverse functionalities to the neural processor, where a particular functionality may be based on synaptic weights stored in a memory card currently attached to the neural processor.

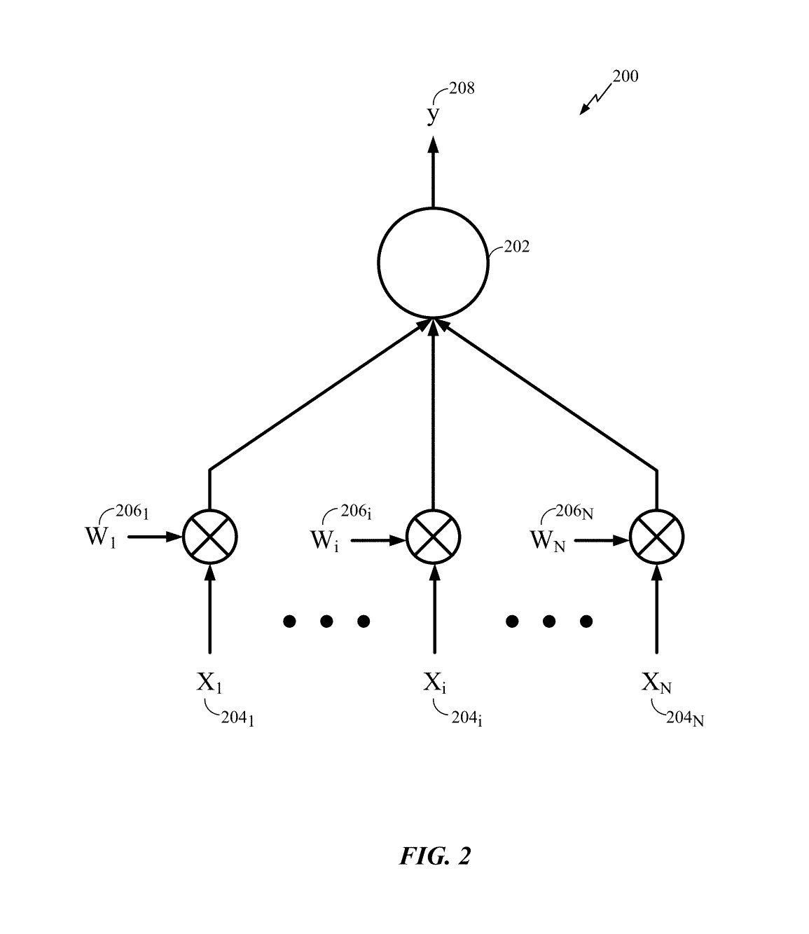

FIG. 2 illustrates an exemplary diagram 200 of a processing unit (e.g., a neuron or neuron circuit) 202 of a computational network (e.g., a neural system or a neural network) in accordance with certain aspects of the present disclosure. For example, the neuron 202 may correspond to any of the neurons of levels 102 and 106 from FIG. 1. The neuron 202 may receive multiple input signals 204₁-204_{N}, which may be signals external to the neural system, or signals generated by other neurons of the same neural system, or both. The input signal may be a current, a conductance, a voltage, a real-valued, and/or a complex-valued. The input signal may comprise a numerical value with a fixed-point or a floating-point representation. These input signals may be delivered to the neuron 202 through synaptic connections that scale the signals according to adjustable synaptic weights 206₁-206_{N} (W₁-W_{N}), where N may be a total number of input connections of the neuron 202.

The neuron 202 may combine the scaled input signals and use the combined scaled inputs to generate an output signal 208 (i.e., a signal Y). The output signal 208 may be a current, a conductance, a voltage, a real-valued and/or a complex-valued. The output signal may be a numerical value with a fixed-point or a floating-point representation. The output signal 208 may be then transferred as an input signal to other neurons of the same neural system, or as an input signal to the same neuron 202, or as an output of the neural system.

The processing unit (neuron) 202 may be emulated by an electrical circuit, and its input and output connections may be emulated by electrical connections with synaptic circuits. The processing unit 202 and its input and output connections may also be emulated by a software code. The processing unit 202 may also be emulated by an electric circuit, whereas its input and output connections may be emulated by a software code. In an aspect, the processing unit 202 in the computational network may be an analog electrical circuit. In another aspect, the processing unit 202 may be a digital electrical circuit. In yet another aspect, the processing unit 202 may be a mixed-signal electrical circuit with both analog and digital components. The computational network may include processing units in any of the aforementioned forms. The computational network (neural system or neural network) using such processing units may be utilized in a large range of applications, such as image and pattern recognition, machine learning, motor control, and the like.

During the course of training a neural network, synaptic weights (e.g., the weights w₁^{(i,i+1)}, . . . , w_{P}^{(i,i+1)} from FIG. 1 and/or the weights 206₁-206_{N} from FIG. 2) may be initialized with random values and increased or decreased according to a learning rule. Those skilled in the art will appreciate that examples of the learning rule include, but are not limited to the spike-timing-dependent plasticity (STDP) learning rule, the Hebb rule, the Oja rule, the Bienenstock-Copper-Munro (BCM) rule, etc. In certain aspects, the weights may settle or converge to one of two values (i.e., a bimodal distribution of weights). This effect can be utilized to reduce the number of bits for each synaptic weight, increase the speed of reading and writing from/to a memory storing the synaptic weights, and to reduce power and/or processor consumption of the synaptic memory.

### Synapse Type

In hardware and software models of neural networks, the processing of synapse related functions can be based on synaptic type. Synapse types may be non-plastic synapses (no changes of weight and delay), plastic synapses (weight may change), structural delay plastic synapses (weight and delay may change), fully plastic synapses (weight, delay and connectivity may change), and variations thereupon (e.g., delay may change, but no change in weight or connectivity). The advantage of multiple types is that processing can be subdivided. For example, non-plastic synapses may not use plasticity functions to be executed (or waiting for such functions to complete). Similarly, delay and weight plasticity may be subdivided into operations that may operate together or separately, in sequence or in parallel. Different types of synapses may have different lookup tables or formulas and parameters for each of the different plasticity types that apply. Thus, the methods would access the relevant tables, formulas, or parameters for the synapse's type.

There are further implications of the fact that spike-timing dependent structural plasticity may be executed independently of synaptic plasticity. Structural plasticity may be executed even if there is no change to weight magnitude (e.g., if the weight has reached a minimum or maximum value, or it is not changed due to some other reason) s structural plasticity (i.e., an amount of delay change) may be a direct function of pre-post spike time difference. Alternatively, structural plasticity may be set as a function of the weight change amount or based on conditions relating to bounds of the weights or weight changes. For example, a synapse delay may change only when a weight change occurs or if weights reach zero but not if they are at a maximum value. However, it may be advantageous to have independent functions so that these processes can be parallelized reducing the number and overlap of memory accesses.

### Determination of Synaptic Plasticity

Neuroplasticity (or simply “plasticity”) is the capacity of neurons and neural networks in the brain to change their synaptic connections and behavior in response to new information, sensory stimulation, development, damage, or dysfunction. Plasticity is important to learning and memory in biology, as well as for computational neuroscience and neural networks. Various forms of plasticity have been studied, such as synaptic plasticity (e.g., according to the Hebbian theory), spike-timing-dependent plasticity (STDP), non-synaptic plasticity, activity-dependent plasticity, structural plasticity and homeostatic plasticity.

STDP is a learning process that adjusts the strength of synaptic connections between neurons. The connection strengths are adjusted based on the relative timing of a particular neuron's output and received input spikes (i.e., action potentials). Under the STDP process, long-term potentiation (LTP) may occur if an input spike to a certain neuron tends, on average, to occur immediately before that neuron's output spike. Then, that particular input is made somewhat stronger. On the other hand, long-term depression (LTD) may occur if an input spike tends, on average, to occur immediately after an output spike. Then, that particular input is made somewhat weaker, and hence the name “spike-timing-dependent plasticity.” Consequently, inputs that might be the cause of the postsynaptic neuron's excitation are made even more likely to contribute in the future, whereas inputs that are not the cause of the postsynaptic spike are made less likely to contribute in the future. The process continues until a subset of the initial set of connections remains, while the influence of all others is reduced to an insignificant level.

Because a neuron generally produces an output spike when many of its inputs occur within a brief period (i.e., being cumulative sufficient to cause the output), the subset of inputs that typically remains includes those that tended to be correlated in time. In addition, because the inputs that occur before the output spike are strengthened, the inputs that provide the earliest sufficiently cumulative indication of correlation will eventually become the final input to the neuron.

The STDP learning rule may effectively adapt a synaptic weight of a synapse connecting a presynaptic neuron to a postsynaptic neuron as a function of time difference between spike time tₚᵣₑ of the presynaptic neuron and spike time tₚₒₛₜ of the postsynaptic neuron (i.e., t=tₚₒₛₜ−tₚᵣₑ). A typical formulation of the STDP is to increase the synaptic weight (i.e., potentiate the synapse) if the time difference is positive (the presynaptic neuron fires before the postsynaptic neuron), and decrease the synaptic weight (i.e., depress the synapse) if the time difference is negative (the postsynaptic neuron fires before the presynaptic neuron).

In the STDP process, a change of the synaptic weight over time may be typically achieved using an exponential decay, as given by:

$$Δ w ( t ) = \{ \begin{matrix}{a}_{+} {e}^{- t / {k}_{+}} + μ , & t > 0 \\ {a}_{-} {e}^{t / {k}_{-}} , & t < 0\end{matrix} , \qquad ( 1 )$$

where k₊ and k₋τ_{sign(Δt)} are time constants for positive and negative time difference, respectively, a₊ and a₋ are corresponding scaling magnitudes, and μ is an offset that may be applied to the positive time difference and/or the negative time difference.

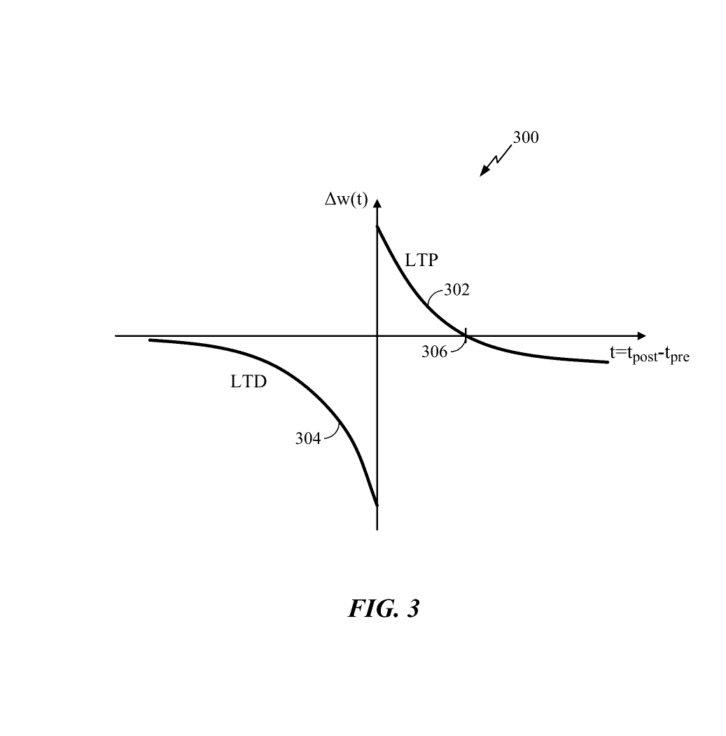

FIG. 3 illustrates an exemplary diagram 300 of a synaptic weight change as a function of relative timing of presynaptic and postsynaptic spikes in accordance with the STDP. If a presynaptic neuron fires before a postsynaptic neuron, then a corresponding synaptic weight may be increased, as illustrated in a portion 302 of the graph 300. This weight increase can be referred to as an LTP of the synapse. It can be observed from the graph portion 302 that the amount of LTP may decrease roughly exponentially as a function of the difference between presynaptic and postsynaptic spike times. The reverse order of firing may reduce the synaptic weight, as illustrated in a portion 304 of the graph 300, causing an LTD of the synapse.

As illustrated in the graph 300 in FIG. 3, a negative offset μ may be applied to the LTP (causal) portion 302 of the STDP graph. A point of cross-over 306 of the x-axis (y=0) may be configured to coincide with the maximum time lag for considering correlation for causal inputs from layer i−1. In the case of a frame-based input (i.e., an input that is in the form of a frame of a particular duration comprising spikes or pulses), the offset value μ can be computed to reflect the frame boundary. A first input spike (pulse) in the frame may be considered to decay over time either as modeled by a postsynaptic potential directly or in terms of the effect on neural state. If a second input spike (pulse) in the frame is considered correlated or relevant to a particular time frame, then the relevant times before and after the frame may be separated at that time frame boundary and treated differently in plasticity terms by offsetting one or more parts of the STDP curve such that the value in the relevant times may be different (e.g., negative for greater than one frame and positive for less than one frame). For example, the negative offset μ may be set to offset LTP such that the curve actually goes below zero at a pre-post time greater than the frame time and it is thus part of LTD instead of LTP.

### Neuron Models and Operation

There are some general principles for designing a useful spiking neuron model. A good neuron model may have rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive, a good neuron model may have a closed-form solution in continuous time and stable behavior including near attractors and saddle points. In other words, a useful neuron model is one that is practical and that can be used to model rich, realistic and biologically-consistent behaviors, as well as be used to both engineer and reverse engineer neural circuits.

A neuron model may depend on events, such as an input arrival, output spike or other event whether internal or external. To achieve a rich behavioral repertoire, a state machine that can exhibit complex behaviors may be desired. If the occurrence of an event itself, separate from the input contribution (if any), can influence the state machine and constrain dynamics subsequent to the event, then the future state of the system is not only a function of a state and input, but rather a function of a state, event, and input.

In an aspect, a neuron n may be modeled as a spiking leaky-integrate-and-fire neuron with a membrane voltage vₙ(t) governed by the following dynamics:

$$\frac{d {v}_{n} ( t )}{d t} = α {v}_{n} ( t ) + β {\sum }_{m} {w}_{m , n} {y}_{m} ( t - Δ {t}_{m , n} ) , \qquad ( 2 )$$

where α and β are parameters, w_{m,n} is a synaptic weight for the synapse connecting a presynaptic neuron m to a postsynaptic neuron n, and yₘ(t) is the spiking output of the neuron m that may be delayed by dendritic or axonal delay according to Δt_{m,n} until arrival at the neuron n's soma.

It should be noted that there is a delay from the time when sufficient input to a postsynaptic neuron is established until the time when the postsynaptic neuron actually fires. In a dynamic spiking neuron model, such as Izhikevich's simple model, a time delay may be incurred if there is a difference between a depolarization threshold vₜ and a peak spike voltage vₚₑₐₖ. For example, in the simple model, neuron soma dynamics can be governed by the pair of differential equations for voltage and recovery, i.e.:

$$\begin{matrix}\frac{d v}{d t} = ( k ( v - {v}_{t} ) ( v - {v}_{r} ) - u + I ) * C , & ( 3 ) \\ \frac{d u}{d u} = a ( b ( v - {v}_{r} ) - u ) , & ( 4 )\end{matrix}$$

where v is a membrane potential, u is a membrane recovery variable, k is a parameter that describes time scale of the membrane potential v, a is a parameter that describes time scale of the recovery variable u, b is a parameter that describes sensitivity of the recovery variable u to the sub-threshold fluctuations of the membrane potential v, vᵣ is a membrane resting potential, I is a synaptic current, and C is a membrane's capacitance. In accordance with this model, the neuron is defined to spike when v>vₚₑₐₖ.

### Hunzinger Cold Model

The Hunzinger Cold neuron model is a minimal dual-regime spiking linear dynamical model that can reproduce a rich variety of neural behaviors. The model's one- or two-dimensional linear dynamics can have two regimes, wherein the time constant (and coupling) can depend on the regime. In the sub-threshold regime, the time constant, negative by convention, represents leaky channel dynamics generally acting to return a cell to rest in a biologically-consistent linear fashion. The time constant in the supra-threshold regime, positive by convention, reflects anti-leaky channel dynamics generally driving a cell to spike while incurring latency in spike-generation.

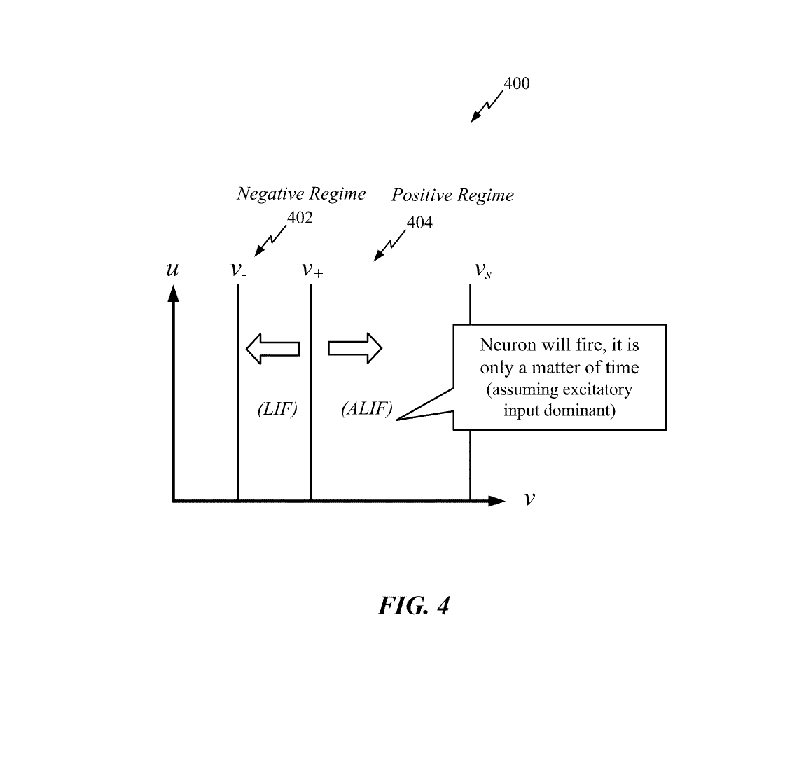

As illustrated in FIG. 4, the dynamics of the model 400 may be divided into two (or more) regimes. These regimes may be called the negative regime 402 (also interchangeably referred to as the leaky-integrate-and-fire (LIF) regime, not to be confused with the LIF neuron model) and the positive regime 404 (also interchangeably referred to as the anti-leaky-integrate-and-fire (ALIF) regime, not to be confused with the ALIF neuron model). In the negative regime 402, the state tends toward rest (v₋) at the time of a future event. In this negative regime, the model generally exhibits temporal input detection properties and other sub-threshold behavior. In the positive regime 404, the state tends toward a spiking event (vₛ). In this positive regime, the model exhibits computational properties, such as incurring a latency to spike depending on subsequent input events. Formulation of dynamics in terms of events and separation of the dynamics into these two regimes are fundamental characteristics of the model.

Linear dual-regime bi-dimensional dynamics (for states v and u) may be defined by convention as:

$$\begin{matrix}{τ}_{ρ} \frac{d v}{d t} = v + {q}_{ρ} & ( 5 ) \\ - {τ}_{u} \frac{d u}{d t} = u + r , & ( 6 )\end{matrix}$$

where q_{ρ} and r are the linear transformation variables for coupling.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) v and recovery current u. In basic form, the regime is essentially determined by the model state. There are subtle, but important aspects of the precise and general definition, but for the moment, consider the model to be in the positive regime 404 if the voltage v is above a threshold v₊ and otherwise in the negative regime 402.

The regime-dependent time constants include τ₋ which is the negative regime time constant, and τ₊ which is the positive regime time constant. The recovery current time constant τᵤ is typically independent of regime. For convenience, the negative regime time constant τ₋ is typically specified as a negative quantity to reflect decay so that the same expression for voltage evolution may be used as for the positive regime in which the exponent and τ₊ will generally be positive, as will be τᵤ.

The dynamics of the two state elements may be coupled at events by transformations offsetting the states from their null-clines, where the transformation variables are:

q_{ρ}=−τ_{ρ}βu−v_{ρ} (7)

r=δ(v+ε), (8)

where δ, ε, β and v₋, v₊ are parameters. The two values for v_{ρ} are the base for reference voltages for the two regimes. The parameter v₋ is the base voltage for the negative regime, and the membrane potential will generally decay toward v₋ in the negative regime. The parameter v₊ is the base voltage for the positive regime, and the membrane potential will generally tend away from v₊ in the positive regime.

The null-clines for v and u are given by the negative of the transformation variables q_{ρ} and r, respectively. The parameter δ is a scale factor controlling the slope of the u null-cline. The parameter ε is typically set equal to −v₋. The parameter β is a resistance value controlling the slope of the v null-clines in both regimes. The τ_{ρ} time-constant parameters control not only the exponential decays, but also the null-cline slopes in each regime separately.

The model may be defined to spike when the voltage v reaches a value vₛ. Subsequently, the state may be reset at a reset event (which may be one and the same as the spike event):

v=\hat{v}₋ (9)

u=u+Δu, (10)

where \hat{v}₋ and Au are parameters. The reset voltage \hat{v}₋ is typically set to v₋.

By a principle of momentary coupling, a closed form solution is possible not only for state (and with a single exponential term), but also for the time to reach a particular state. The close form state solutions are:

$$\begin{matrix}v ( t + Δ t ) = ( v ( t ) + {q}_{ρ} ) {e}^{\frac{Δ t}{{τ}_{ρ}}} - {q}_{ρ} & ( 11 ) \\ u ( t + Δ ) = ( u ( t ) + r ) {e}^{\frac{- Δ t}{{τ}_{u}}} - r . & ( 12 )\end{matrix}$$

Therefore, the model state may be updated only upon events, such as an input (presynaptic spike) or output (postsynaptic spike). Operations may also be performed at any particular time (whether or not there is input or output).

Moreover, by the momentary coupling principle, the time of a postsynaptic spike may be anticipated so the time to reach a particular state may be determined in advance without iterative techniques or Numerical Methods (e.g., the Euler numerical method). Given a prior voltage state v₀, the time delay until voltage state v_{f} is reached is given by:

$$Δ t = {τ}_{ρ} log \frac{{v}_{f} + {q}_{ρ}}{{v}_{0} + {q}_{ρ}} . \qquad ( 13 )$$

If a spike is defined as occurring at the time the voltage state v reaches vₛ, then the closed-form solution for the amount of time, or relative delay, until a spike occurs as measured from the time that the voltage is at a given state v is:

$$Δ {t}_{S} = \{ \begin{matrix}{τ}_{+} log \frac{{v}_{S} + {q}_{+}}{v + {q}_{+}} & if v > {\hat{v}}_{+} \\ ∞ & otherwise\end{matrix} \qquad ( 14 )$$

where \hat{v}₊ is typically set to parameter v₊, although other variations may be possible.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

There are several possible implementations of the Cold model, and executing the simulation, emulation or model in time. This includes, for example, event-update, step-event update, and step-update modes. An event update is an update where states are updated based on events or “event update” (at particular moments). A step update is an update when the model is updated at intervals (e.g., 1 ms). This does not necessarily utilize iterative methods or Numerical methods. An event-based implementation is also possible at a limited time resolution in a step-based simulator by only updating the model if an event occurs at or between steps or by “step-event” update.

Artificial Neurons and Spiking Neurons with Asynchronous Pulse Modulation

Aspects of the present disclosure are directed to configuring artificial neurons and/or spiking neurons with asynchronous pulse modulation.

Asynchronous pulse modulators (APMs) may encode signals into unipolar spike trains, bipolar spike trains or multi-valued spikes. Furthermore, the spike response model (SRM) neuron and leaky integrate and fire (LIF) neuron are special forms of APMs known as asynchronous pulse delta modulators (APDMs).

In accordance with aspects of the present disclosure, spiking neurons are configured using APMs. In one exemplary aspect, the spiking neuron is configured in the form of a spatial processor. In this form, a single synapse may be provided between each presynaptic neuron and a postsynaptic neuron.

In a second exemplary aspect, the spiking neuron is configured in the form of a space-time processor. In this configuration, multiple synapses may be provided between a presynaptic neuron and a postsynaptic neuron.

In a third exemplary aspect, the spiking neuron may be configured in the form of a temporal processor. In this configuration, a more simplified spiking neuron may be realized in which multiple synapses may be provided between a single presynaptic neuron and a postsynaptic neuron.

### The Artificial Neuron

The conventional discrete-time sampled artificial neuron (AN) and its continuous-time version are described below. Assuming a common sampling rate of 1/T across all ANs, the kth sampled squashed dot-product output of the AN can be expressed as:

x(kT)=σ[y(kT)], (15)

where σ(•) represents the activation function and y(kT) represents the biased dot-product:

y(kT)=w₀+Σₙ₌₁^{N}wₙx_{pre,n}(kT)], (16)

where w₀ represents a bias term, {wₙ|n=1, 2, . . . N} represents the synaptic weights and x_{pre,n}(kT), the kth time sample of the squashed dot-product output of the nth presynaptic neuron. The squashed dot-product output represents a similarity measure indicating the level of similarity between the input vector:

x(kT)=[x_{pre,1}(kT),x_{pre,2}(kT), . . . ,x_{pre,N}(kn), (17)

and the spatial synaptic weight vector w=[w₁, w₂, . . . , w_{N}].

A y(kT) value of 1, 0 and −1 may represent, respectively, maximum similarity, no similarity and anti-similarity.

The sampling rate may satisfy the Nyquist Sampling Theorem and be larger than or equal to double the maximum bandwidth across the signals {x_{pre,n}(kT)|n=1, 2, . . . , N}.

The accuracy and computational complexity of the uniformly time-sampled AN depends on the sampling rate 1/T. As 1/T increases, the accuracy increases at the cost of computational complexity. Assuming an M-bit amplitude quantization, then each presynaptic neuron may utilize a constant bit transmission rate of M/T [bps].

### The Continuous-Time AN

The continuous-time squashed dot-product output of the AN can be expressed as:

x(t)=σ[y(t)], (18)

where σ(•) represents the activation function and y(t) represents the continuous-time biased dot-product:

y(t)=w₀+Σₙ₌₁^{N}wₙx_{pre,n}(t), (19)

where w₀ represents a bias term, {wₙ|n=1, 2, . . . N} represents the spatial weights, which may be referred to as synaptic weights and x_{pre,n}(t), the squashed dot-product output of the nth presynaptic neuron.

The squashed dot-product x(t) measures how “similar” the time-varying manner spatial signal vector xₚᵣₑ(t)=└x_{pre,1}(t), . . . , x_{pre,N}(t)┘ is with the spatial synaptic weight vector wₚᵣₑ=[w₁, . . . , w_{1N}]. For example, a value of 1 may represent similarity and 0 may represent no similarity. Further, if an activation function with a range of [−1,1] is used, then −1 may represent anti-similarity. Although, the activation function in the above example has been described as the squashed dot product, the present disclosure is not so limited. Rather, the activation function may also comprise a radial basis function, a sigmoidal function, hyperbolic tangent and piecewise linear activation functions or other forms of activation functions.

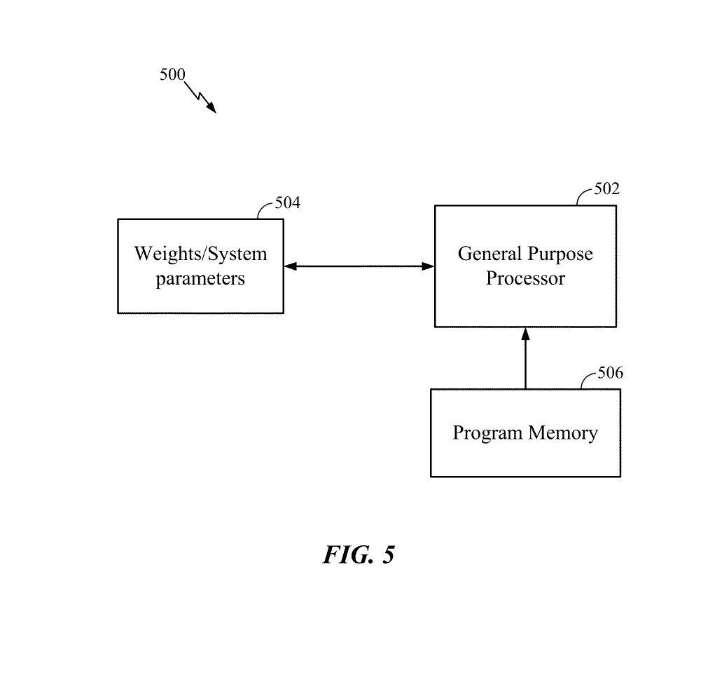

FIG. 5 illustrates an example implementation 500 of the aforementioned artificial neuron configuration using a general-purpose processor 502 in accordance with certain aspects of the present disclosure. Variables (neural signals), synaptic weights, system parameters associated with a computational network (neural network), delays, and frequency bin information may be stored in a memory block 504, while instructions executed at the general-purpose processor 502 may be loaded from a program memory 506. In an aspect of the present disclosure, the instructions loaded into the general-purpose processor 502 may comprise code to receive a set of input spike trains comprising an asynchronous pulse coding representation of prior continuous time input signals. Further, the instructions loaded into the general-purpose processor 502 may comprise code to generate output spikes representing a similarity between the set of input spike trains and a spatial-temporal weight vector.

In another aspect of the present disclosure, the instructions may comprise code to generate output spikes representing a similarity between the set of input spike trains and a spatial weight vector. In yet another aspect of the present disclosure, the instructions may comprise code to generate output spikes representing a similarity between the set of input spike trains and a temporal filter based on the set of input spike trains.

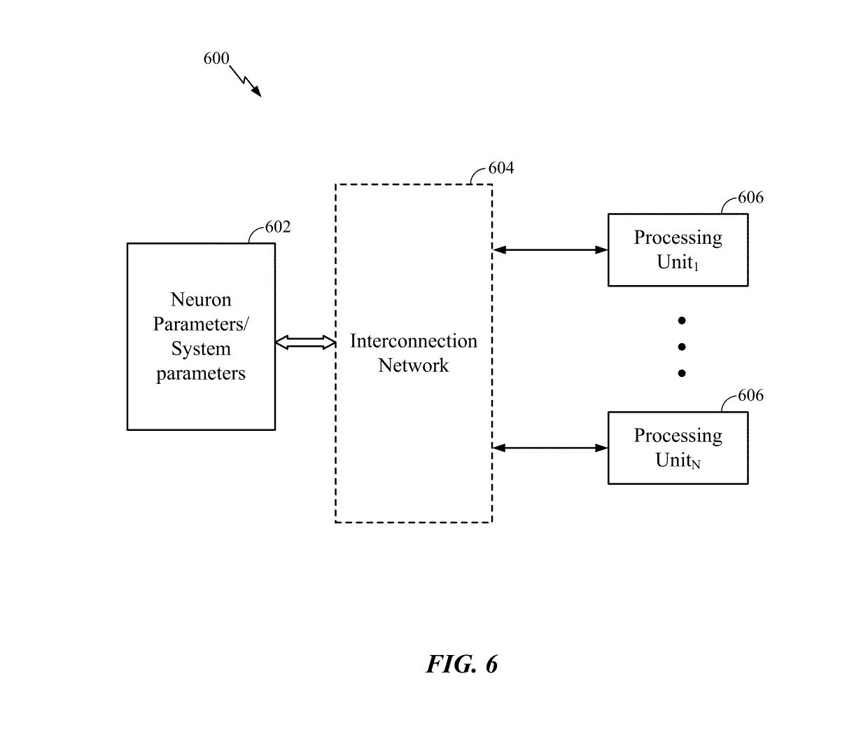

FIG. 6 illustrates an example implementation 600 of the aforementioned neuron configuration where a memory 602 can be interfaced via an interconnection network 604 with individual (distributed) processing units (neural processors) 606 of a computational network (neural network) in accordance with certain aspects of the present disclosure. Variables (neural signals), synaptic weights, system parameters associated with the computational network (neural network) delays, and frequency bin information may be stored in the memory 602, and may be loaded from the memory 602 via connection(s) of the interconnection network 604 into each processing unit (neural processor) 606. In an aspect of the present disclosure, the processing unit 606 may be configured to receive a set of input spike trains comprising an asynchronous pulse coding representation of prior continuous time input signals. Further, the processing unit 606 may be configured to generate output spikes representing a similarity between the set of input spike trains and a spatial-temporal weight vector.

In another aspect of the present disclosure, the processing unit 606 may be configured to generate output spikes representing a similarity between the set of input spike trains and a spatial weight vector. In yet another aspect of the present disclosure, the processing unit 606 may be configured to generate output spikes representing a similarity between the set of input spike trains and a temporal filter.

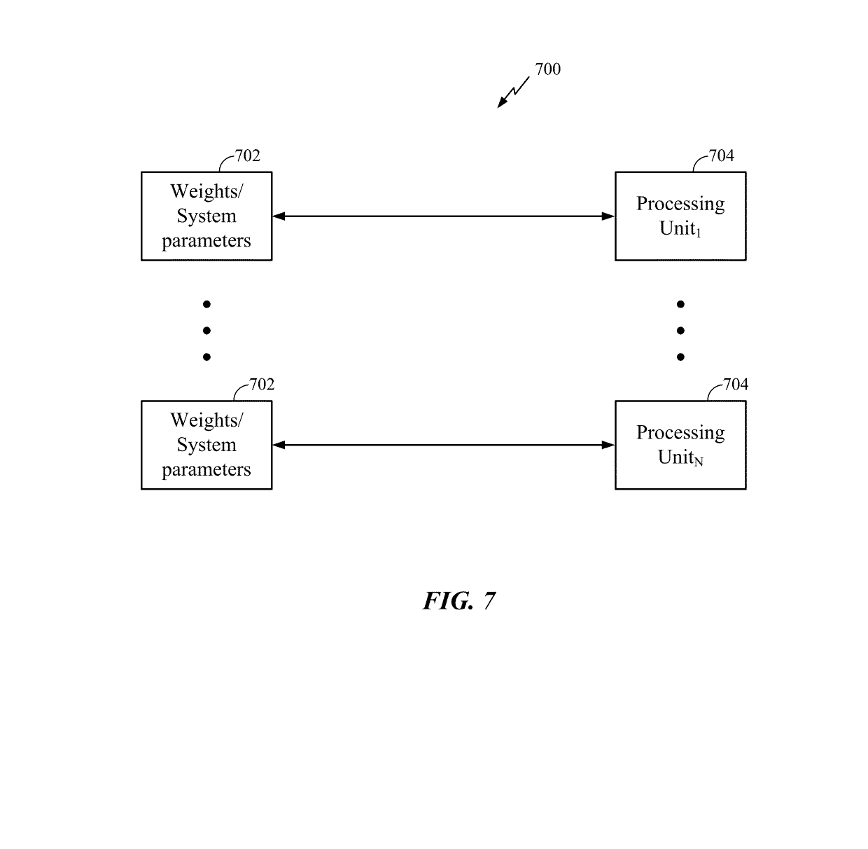

FIG. 7 illustrates an example implementation 700 of the aforementioned neuron configuration. As illustrated in FIG. 7, one memory bank 702 may be directly interfaced with one processing unit 704 of a computational network (neural network). Each memory bank 702 may store variables (neural signals), synaptic weights, and/or system parameters associated with a corresponding processing unit (neural processor) 704 delays, and frequency bin information. In an aspect of the present disclosure, the processing unit 704 may be configured to receive a set of input spike trains comprising an asynchronous pulse coding representation of prior continuous time input signals. Further, the processing unit 704 may be configured to generate output spikes representing a similarity between the set of input spike trains and a spatial-temporal filter.

In another aspect of the present disclosure, the processing unit 704 may be configured to generate output spikes representing a similarity between the set of input spike trains and a spatial weight vector. In yet another aspect of the present disclosure, the processing unit 704 may be configured to generate output spikes representing a similarity between the set of input spike trains and a temporal filter.

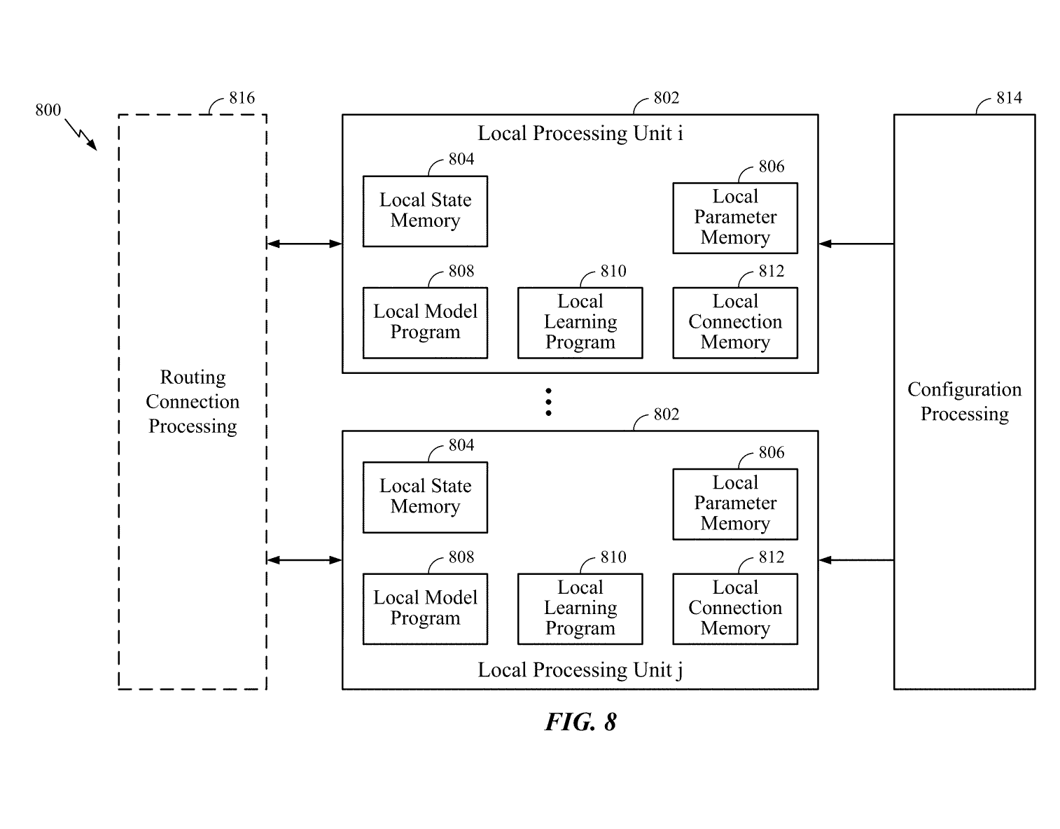

FIG. 8 illustrates an example implementation of a neural network 800 in accordance with certain aspects of the present disclosure. As illustrated in FIG. 8, the neural network 800 may have multiple local processing units 802 that may perform various operations of methods described herein. Each local processing unit 802 may comprise a local state memory 804 and a local parameter memory 806 that store parameters of the neural network. In addition, the local processing unit 802 may have a local (neuron) model program (LMP) memory 808 for storing a local model program, a local learning program (LLP) memory 810 for storing a local learning program, and a local connection memory 812. Furthermore, as illustrated in FIG. 8, each local processing unit 802 may be interfaced with a configuration processor unit 814 for providing configurations for local memories of the local processing unit, and with a routing connection processing units 816 that provide routing between the local processing units 802.

In one configuration, a neuron model is configured for receiving a set of input spike trains comprising an asynchronous pulse coding representation of prior continuous time input signals and/or generating output spikes representing a similarity between the set of input spike trains and a spatial-temporal filter. The neuron model includes receiving means and generating means. In one aspect, the receiving means and/or generating means may be the general-purpose processor 502, program memory 506, memory block 504, memory 602, interconnection network 604, processing units 606, processing unit 704, local processing units 802, and or the routing connection processing units 816 configured to perform the functions recited. In another configuration, the aforementioned means may be any module or any apparatus configured to perform the functions recited by the aforementioned means.

In another configuration, a neuron model is configured for receiving a set of input spike trains comprising an asynchronous pulse coding representation of prior continuous time input signals and/or generating output spikes representing a similarity between the set of input spike trains and a spatial weight vector. The neuron model includes receiving means and generating means. In one aspect, the receiving means and/or generating means may be the general-purpose processor 502, program memory 506, memory block 504, memory 602, interconnection network 604, processing units 606, processing unit 704, local processing units 802, and or the routing connection processing units 816 configured to perform the functions recited. In another configuration, the aforementioned means may be any module or any apparatus configured to perform the functions recited by the aforementioned means.

In yet another configuration, a neuron model is configured for receiving a set of input spike trains comprising an asynchronous pulse coding representation of prior continuous time input signals and/or generating output spikes representing a similarity between the set of input spike trains and a temporal filter. The neuron model includes receiving means and generating means. In one aspect, the receiving means and/or generating means may be the general-purpose processor 502, program memory 506, memory block 504, memory 602, interconnection network 604, processing units 606, processing unit 704, local processing units 802, and or the routing connection processing units 816 configured to perform the functions recited. In another configuration, the aforementioned means may be any module or any apparatus configured to perform the functions recited by the aforementioned means.

According to certain aspects of the present disclosure, each local processing unit 802 may be configured to determine parameters of the neural network based upon desired one or more functional features of the neural network, and develop the one or more functional features towards the desired functional features as the determined parameters are further adapted, tuned and updated.

### The Asynchronous Pulse Modulation (APM) Encoder and Decoder

The APM encoder converts a continuous-time input signal x(t) into an output spike train s(t) sent over a channel. In one exemplary aspect, the spike train may be positive and unipolar. However, the present disclosure is not so limited and in some aspects, the spike train may be negative unipolar, bipolar and/or multi-valued.

An output spike train may be transmitted or provided to one or more postsynaptic neurons via a channel. In some aspects, the channel can be likened to the axon, the APM decoder as the synapse of the postsynaptic neuron and the APM encoder as part of the presynaptic neuron. In an ideal channel, the received spike train r(t)=s(t). As such, the received spike train r(t) may comprise an asynchronous pulse coding representation of a continuous time input signal from a presynaptic neuron. The APM decoder may convert r(t) into an estimate \hat{x}(t) of the input signal x(t).

In some aspects, the APM encoder and APM decoder may form a pair in that the decoder is ‘matched’ to the encoder. For example, a reconstruction filter (or delta filter) at the encoder and decoder may match. Further, if a smoothing filter (e.g., an anti-aliasing filter (AAF)) is included, the smoothing filter may be configured with a bandwidth roughly matched to that of the input signal x(t). Accordingly, APM encoder n may be designed to match with APM decoder n. Furthermore, each encoder/decoder pair may be distinct.

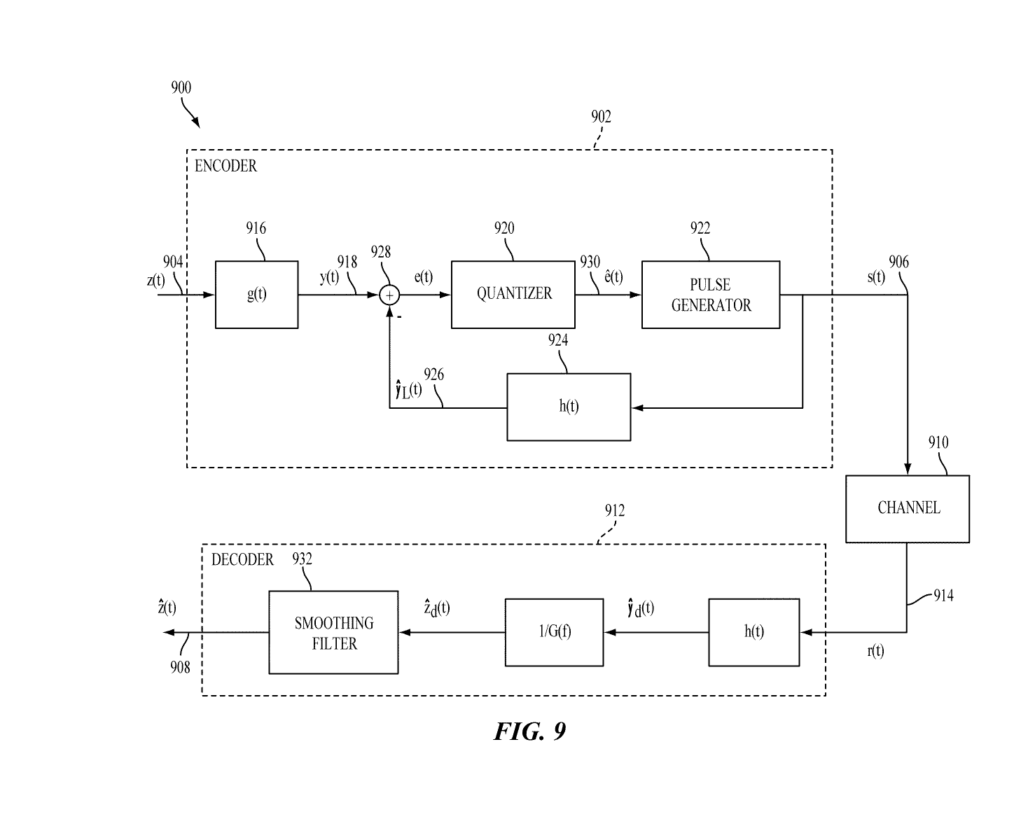

FIG. 9 illustrates an exemplary encoder/decoder pair of an asynchronous pulse modulator (APM) neuron in accordance with an aspect of the present disclosure. FIG. 9 illustrates an APM 900 employing an encoder 902 to encode an input signal z(t) 904 into a transmit signal s(t) 906 and reconstructs an estimate \hat{z}(t) 908 of the input signal 904 across a channel 910 at a decoder 912. The channel 910 may be assumed as an ideal channel for ease in explanation such that the received signal 914 at the decoder 912 r(t)=s(t) with the understanding that channel noise and distortion (e.g., multipath channels, time-varying attenuation) can be introduced and affect system design.

In some aspects, the encoder 902 may include a linear time-invariant (LTI) pre-filter 916 g(t) for pre-shaping the input signal 904 z(t) and generating a filtered signal 918:

y(t)=z(t)*g(t) (20)

The LTI pre-filter 916 may be referred to as a “sigma” or integrating filter. If the LTI pre-filter 916 is present, then the APM 900 may be referred to as an asynchronous pulse sigma-delta modulator (APSDM). If the LTI pre-filter 916 is absent, then y(t)=z(t) and the APM may be referred to as an asynchronous pulse delta modulator (APDM).

The encoder 902 also includes a quantizer 920, a signal generator 922 (which may be a pulse generator), and a reconstruction filter 924. The quantizer 920, the signal generator 922, and the reconstruction filter 924 in combination may be referred to as a generalized asynchronous pulse delta modulator (APDM) encoder that encodes changes or “deltas” in the filtered signal 918 y(t). The filtered signal 918 y(t) is supplied to an adder 928 and subtracted by a local reconstruction signal 926 ŷ_{L}(t) to generate a difference signal:

e(t)=y(t)−ŷ_{L}(t). (21)

The amplitude of the difference signal is quantized by the quantizer 920 yielding the signal 930:

\hat{e}(t)=Q[e(t)]. (22)

Though the signal e(t) may be continuous-valued, in some aspects, it may take on one or more discrete values. The quantizer 920 can also take a number of forms. For example, the quantizer may have one, two or multiple thresholds. The quantized difference signal 930 ê(t) is then passed through the signal generator 922 to produce the transmit signal 906:

s(t)=Σₘ₌₁^{M}a(m)p(t−Tₘ), (23)

where M represents the total number of output pulses generated by the encoder, p(t) represents the transmit pulse shape with unit energy, Tₘ is the time instant associated with the mth occurrence of a positive change (reaching or exceeding an upper threshold) and/or a negative change (reaching or exceeding a lower threshold) in ê(t) where mε[1, M] and T₁<T₂< . . . <T_{M}, and a(m) is a scaling value or factor associated with the mth pulse. For example, a(m) may represent 1 or any positive or negative set of values (e.g., ±1, ±2).

In one aspect, the pulses may have large bandwidth that resembles an impulse function δ(t). These include pulses like sinc(Bt) where B>>1, the raised cosine pulse described later (with Bₘ>>1 and roll-factor of β) and a thin rectangular pulse

$$\frac{1}{{T}^{( p )}} [ {u}_{s} ( t ) - {u}_{s} ( t - {T}^{( p )} ) ]$$

where T^{(p)}<<1 and uₛ(t) is the unit step function:

$${u}_{s} ( v ) = \{ \begin{matrix}0 , & v < 0 \\ 1 , & v \geq 0\end{matrix} \qquad ( 24 )$$

In some aspects, the transmit signal 906 may be viewed as a transformation of the time-instant sequence {T₁, T₂, . . . , T_{M}} when thresholds are reached to a train of pulses. The transmit signal 906 may also be thought of as pulse time modulation, where each time instant determines the instant the pulse is generated.

The transmit signal 906 may then be fed back into the reconstruction filter 924 h(t) (also referred to as a Delta filter) to yield the reconstruction signal 926:

ŷ_{L}(t)=s(t)*h(t) (25)

ŷ_{L}(t)=Σₘ₌₁^{M}a(m)h(t−Tₘ). (26)

For continuous-time systems, a clock is not used and the signaling time instants {Tₘ|mε[1, M]} are continuous valued. On the other hand, for discrete-time systems, which may use a clock, the signal time instants {Tₘ|mε[1, M]}, may be quantized (e.g., to the nearest 1 ms). This yields discrete-time versions of the APM 900.

In some aspects, the quantizer 920 and signal generator 922 may be combined if desired. Furthermore, a smoothing filter 932 (e.g., an anti-aliasing filter (AAF)) may be inserted prior to the pre-filter to remove out-of-band noise. The smoothing filter 932 may be a low-pass filter (LPF) or band-pass filter (BPF), for example. In some aspects, the bandwidth of the smoothing filter 932 may be set to approximate the bandwidth of z(t).

The quantizer 920 may be provided in a variety of configurations. For example, the quantizer 920 may be single-sided or double-sided. A single-sided quantizer may, for instance, include an upper-threshold quantizer or a lower-threshold quantizer.

Upper-threshold quantizers may encode signals with a minimum value, which may, for instance, be zero. Upper-threshold quantizers may have a single threshold or multiple thresholds for quantization of input signals.

The difference signal is mapped to the quantized difference signal via:

$$\hat{e} ( t ) {=}^{Δ} a {u}_{s} [ e ( t ) - \frac{Δ}{2} ] , \qquad ( 27 )$$

such that ê(t)ε{0, a}, ê(t)=a if e(t)≧Δ/2 and ê(t)=0, otherwise where a>0 represents the quantized value. For ease of explanation, and without limitation, the scaling factor a may be set to 1. Accordingly, the quantizer 920 may produce transmit signals in the form of single positive-valued pulse trains scaled by a factor of a (e.g., similar to spikes in spiking neural networks) which may also be referred to as unipolar signaling or point processes. The transmit signals may be given by:

s(t)=aΣₘ₌₁^{M}δ(t−Tₘ). (28)

In some aspects, the design of the threshold value impacts the reconstruction filter design. In one example, a threshold value of Δ/2 and an h(t)ε[0, Δ] defined later may produce an

$$e ( t ) ∈ [ - \frac{Δ}{2} , \frac{Δ}{2} ] .$$

In another example, a threshold value of Δ and an h(t)ε[0, Δ] may produce e(t)ε[0, Δ]. The first approach results in smaller absolute values of the difference signal. This comment applies not only to the upper-threshold quantizers but to all quantizers described in this document.

The time instants {Tₘ|m=1, . . . , M} correspond to the instants that ê(t) is above or equal to the threshold.

Multiple positive thresholds can be introduced to handle input signals with fast positive-valued changes, where e(t)>>Δ/2, which can occur if e(t) changes quickly during a down-time or refractory period during which the encoder may not transmit (e.g., due to recharging of power resources). An example of a double-threshold single-sided quantizer is described below.

The difference signal is mapped to the quantized difference signal via:

$$\hat{e} ( t ) {=}^{Δ} \{ \begin{matrix}a , & if Δ / 2 \leq e ( t ) < 3 Δ / 2 \\ 2 a , & if e ( t ) \geq 3 Δ / 2 \\ 0 , & otherwise\end{matrix} , \qquad ( 29 )$$

such that ê(t)ε{0, a, 2a}. This quantizer results in transmit signals in the form of two discrete-valued pulse trains. These result in transmit signals of the form:

s(t)=Σₘ₌₁^{M}a(m)δ(t−Tₘ), (30)

where a(m)ε{a, 2a}. The time instants {Tₘ|m=1, . . . , M} correspond to the instants that e(t) is above a threshold.

Lower-threshold quantizers are intended for encoding signals below a maximum value. For ease in explanation, we assume a maximum value of 0 such that the encoding is for non-positive signals. Lower-threshold quantizers may also have one or more thresholds for quantizing input signals.

The difference signal may be mapped to the quantized difference signal via:

$$\hat{e} ( t ) {=}^{Δ} - a {u}_{s} [ - e ( t ) - \frac{Δ}{2} ] , \qquad ( 31 )$$

such that ê(t)ε{0, −a} and ê(t)=−a if e(t)≦−Δ/2 and ê(t)=0, otherwise. The value a represents the quantized value (e.g., a=1). This quantizer results in transmit signals in the form of single negative-valued pulse trains that may be given by:

s(t)=−aΣₘ₌₁^{M}δ(t−Tₘ), (32)

where the time instants {Tₘ|m=1, . . . , M} correspond to the instants that ê(t) is below or equal to the threshold.

As with the upper-threshold threshold quantizers, multiple lower-threshold thresholds can be introduced to handle input signals with fast negative-valued changes, where ê(t)<<−Δ/2.

The difference signal is mapped to the quantized difference signal via:

$$\hat{e} ( t ) {=}^{Δ} \{ \begin{matrix}- a & if - \frac{3 Δ}{2} < e ( t ) \leq - Δ / 2 \\ - 2 a , & if e ( t ) \leq - 3 Δ / 2 \\ 0 , & otherwise\end{matrix} . \qquad ( 33 )$$

This results in transmit signals of the form:

s(t)=Σₘ₌₁^{M}a(m)δ(t−Tₘ), (34)

where a(m)ε{−a, −2a}. The time instants {Tₘ|m=1, . . . , M} correspond to the instants that e(t) is below or equal to a thresholds.

A double-sided quantizer may encode signals that may not have a minimum or maximum. Double-sided quantizers may have both increasing and decreasing valued thresholds. Such quantizers can support the quantization of signals that are unbounded and, if desired, upper-threshold and/or lower-threshold.

The difference signal is mapped to the quantized difference signal via:

$$\hat{e} ( t ) = \{ \begin{matrix}- a , & if e ( t ) \leq - Δ / 2 \\ a , & if e ( t ) \geq Δ / 2 \\ 0 , & otherwise\end{matrix} , \qquad ( 35 )$$

such that e(t)ε{−a, 0, a}. This quantizer results in transmit signals in the form of bipolar pulse trains:

s(t)=Σₘ₌₁^{M}a(m)δ(t−Tₘ), (36)

where a(m)ε{−a, a}. The time instants {Tₘ|m=1, . . . , M} correspond to the instants that e(t) is either above or equal to the positive-valued threshold or below or equal to the negative-valued threshold.

Multiple threshold pairs can be introduced to handle fast changing input signals with |e(t)|>>Δ/2. An example of a double-sided double-threshold-pair quantizer is described below.

The difference signal is mapped to the quantized difference signal via:

$$\hat{e} ( t ) = \{ \begin{matrix}- 2 a , & if e ( t ) \leq - 3 Δ / 2 \\ - a , & if - 3 Δ / 2 < e ( t ) \leq - Δ / 2 \\ a , & if Δ / 2 < e < 3 Δ / 2 \\ 2 a , & if e ( t ) \geq 3 Δ / 2 \\ 0 , & otherwise\end{matrix} , \qquad ( 37 )$$

such that ê(t)ε{0, a, 2a}. This quantizer results in transmit signals in the form of bipolar pulse trains:

s(t)=Σₘ₌₁^{M}a(m)δ(t−Tₘ), (38)

where a(m)ε{−2a, −a, a, 2a}. The time instants {Tₘ|m=1, . . . , M} correspond to the instants that ê(t) is either above or equal to a positive-valued threshold or below or equal to a negative-valued threshold.

If the quantizer 920 is single-sided, then the reconstruction filter 924 may be a decaying filter. A non-decaying reconstruction filter may result in reconstruction signals 926 that are either monotonically increasing for upper-threshold quantizers or monotonically decreasing for lower-threshold quantizers. If the quantizer 920 is double-sided, then either decaying or non-decaying reconstruction filters 924 may be used. A decaying reconstruction filter 924 may have continuous-values or discrete-values.

A non-decaying reconstruction filter may take on the impulse response:

$$h ( t ) {=}^{Δ} \frac{Δ}{a} {u}_{s} ( t ) , \qquad ( 39 )$$

where a scaling factor 1/a may be applied to remove the factor a in the transmit (or receive) signal and scaling factor Δ may be used to track the input signal by an amount matching that defined by the quantizer. In some aspects, Δ=a=1 such that h(t)=uₛ(t).

In some configurations, an arbitrary decaying filter with continuous-valued impulse response may be used. For example, an arbitrary decaying filter may be used when the signal (e.g., input signal) tapers down to zero. In some aspects, the reconstruction filter may be selected based on the decay behavior of the input signal type. For example, for fast decaying input signals, reconstruction filters with fast decays to zero may be used. Otherwise, reconstruction filters with slow decays may be used. For signals with fast rises, reconstruction filters with fast rises may be employed. Otherwise, reconstruction filters with slow rises could be used.

A simple decaying reconstruction filter is the decaying exponential:

$$h ( t ) {=}^{Δ} \frac{Δ}{a} \cdot exp ( - t / {τ}_{d} ) {u}_{s} ( t ) , \qquad ( 40 )$$

where τ_{d} represents the decay time constant and where uₛ(t) represents the unit-step function such that uₛ(t)=1 if t≧0 and uₛ(t)=0, otherwise.

In some aspects, a reconstruction filter with a double exponential may be used. For example, for a smooth rise, rather than an abrupt jump, the double exponential filter may be given by:

$$h ( t ) {=}^{Δ} \frac{Δ}{a} \cdot {A}_{2 exp} ( {e}^{- t / {τ}_{d}} - {e}^{- t / {τ}_{r}} ) \cdot {u}_{s} ( t ) , \qquad ( 41 )$$

where τᵣ represents the rise time constant and the scaling coefficient A₂ₑₓₚ is:

A₂ₑₓₚ [symbol] A_{2exp,peak}/(e^{-T}^{ₚₑₐₖ}^{/τ}^{_{d}}−e^{-T}^{ₚₑₐₖ}^{/τ}^{ᵣ}), (42)

where A_{2exp,peak} represents the peak magnitude of the double exponential (e.g., A_{2exp, peak}=1) and:

$${T}_{peak} {=}^{Δ} \frac{{τ}_{d} {τ}_{r}}{{τ}_{d} - {τ}_{r}} log ( \frac{{τ}_{d}}{{τ}_{r}} ) . \qquad ( 43 )$$

In some aspects, decaying filters with discrete-values may be employed. In one example, the reconstruction filter has the form of a linear decaying staircase function with uniformly spaced discrete values.

The reconstruction filter may also have non-uniformly spaced discrete values and non-uniform durations for each discrete value. In one example, a reconstruction filter with decreasing step sizes adjusted in a telescoping fashion (factor of ½) which can be likened to a discrete-valued version of the decaying exponential may be used.

In still another aspect, the reconstruction filter may have an initial rise and a subsequent decay. For instance the reconstruction filter may initially rise and then have a decaying staircase function that can be likened to a discrete-valued version of the double exponential.

If the channel 910 is ideal (i.e., has no losses or noise), then the decoder 912 sees a received signal 914 equivalent to the transmit signal 906 such that r(t)=s(t).

With APDM and single-sided quantizers for encoding bounded signals, the reconstruction signal (or filter impulse response) may generally tend towards zero. Otherwise, signal encoding may not be possible. For example, APDM with an upper-threshold quantizer and reconstruction filter set to the unit-step function may only encode signals that increase with time and may not encode signals that also decrease with time. On the other hand, a reconstruction filter with a response that tends towards zero sufficiently fast may encode signals that also decay.

The decoder 912 may include a reconstruction filter (similar to the reconstruction filter 924), an inverse filter, and a smoothing filter 932 (e.g., an anti-aliasing filter (AAF)), which, in some aspects, may be configured in a different order and/or combined.

In the APM encoder/decoder pair 900 of the present disclosure, there is an explicit solution for the decoder 912, rather than an estimated numerical solution for the impulse response.

### APM Neuron as a Spatial Processor

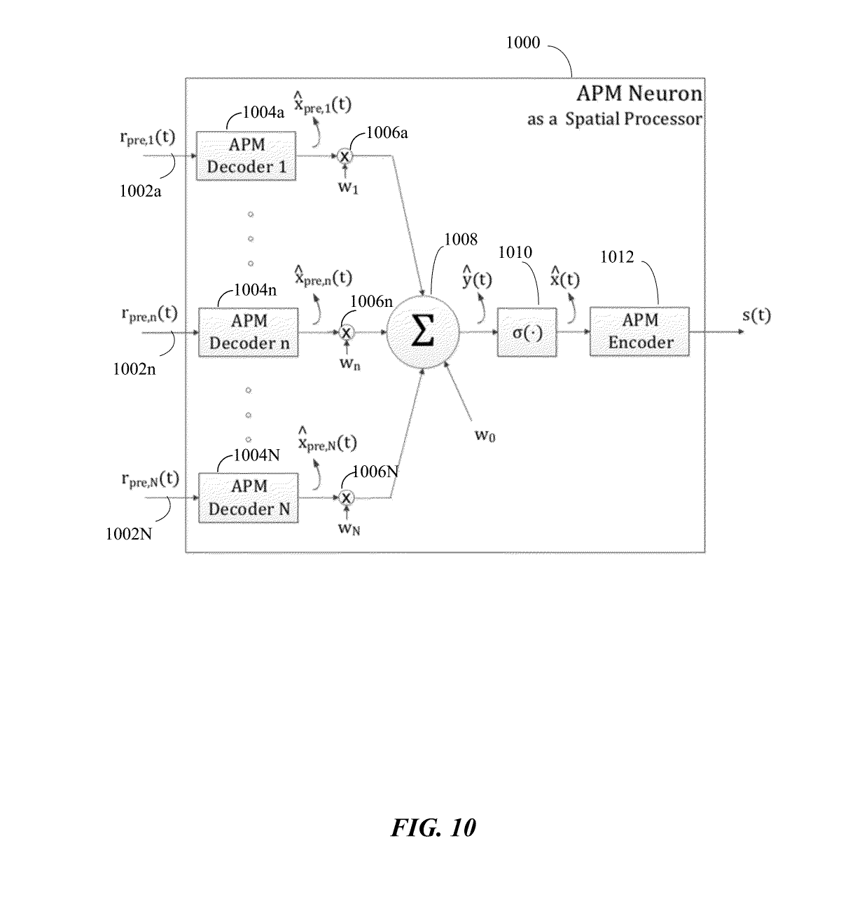

FIG. 10 is a block diagram illustrating an exemplary artificial neuron 1000 configured as a spatial processor. Referring to FIG. 10, the artificial neuron or APM neuron 1000 may comprise one or more APM decoders (e.g., 1004a, 1004n), an activation function node 1010 and an APM encoder 1012.

The APM neuron 1000 may be coupled with N presynaptic neurons where each connection comprises a single synapse (e.g., 1002a, 1002n). Each of the N presynaptic neurons may be configured similarly to the APM 1000. Hence, there may be N pairs of APM encoders and decoders, where APM decoder n is matched to a presynaptic APM encoder n (not shown) where n=1, 2, . . . , N via a corresponding synapse (e.g., 1002a, 1002n, 1002N). In some aspects, the encoder/decoder pairs may be common or the same. For example, each of the N encoder/decoder pairs may be configured to perform the same encoding and decoding techniques. However, the present application is not so limited, and the encoder/decoder pairs may be distinct from one another.

The APM neuron receives N spike train inputs (e.g., r_{pre,1}(t) r_{pre,n}(t)) from N presynaptic neurons (not shown). In some aspects, the presynaptic neurons may comprise APM neurons. The APM encoder n takes the signal x_{pre,n}(t) and generates the spike train s_{pre,n}(t). For ease of explanation, the channel may be assumed to be without noise or attenuation such that the received spike train r_{pre,n}(t)=s_{pre,n}(t) at synapse n. Of course, the present disclosure is not so limited and the received spike train may be calculated under the influence of a noisy channel. Accordingly, the received spike trains may comprise asynchronous pulse coding representations of a prior continuous time input signal.

The APM decoders (e.g., 1004a, 1004N) transform the received spike train r_{pre,n}(t) to a continuous time form estimate \hat{x}_{pre,n}(t) of the squashed dot-product x_{pre,n}(t) associated with a corresponding presynaptic neuron and the underlying continuous-time AN.

The estimate x_{pre,n}(t) may then be multiplied by the nth synaptic weight wₙ via a multiplier (e.g., 1006a, 1006N). Of course, the order of the APM decoder n and the synaptic weight wₙ multiplication may be switched and are mathematically equivalent. When switched, the received spike train r_{pre,n}(t) is first scaled by the synaptic weight before being passed to the APM decoder (e.g., 1004a, 1004N). Though mathematically equivalent, having the multiplication first may be advantageous because the multiplication of the synaptic weight with the incoming spike may only occur when the spike arrival occurs. Otherwise, when the multiplication is later, a constant multiplication (amplification) may be performed. Accordingly, with the present approach, further efficiencies with respect to hardware and system performance may be realized.

The nth APM decoder outputs (x_{pre,n}(t)), which may each be scaled by their corresponding synaptic weight are supplied to a summing node 1008 and summed along with a bias term w₀ as follows:

\hat{y}(t)=w₀+Σₙ₌₁^{N}wₙ\hat{x}_{pre,n}(t), (44)

where ŷ(t) is an estimate of the biased dot-product y(t) associated with the underlying continuous-time AN. This dot-product estimate may then be passed to an activation function node 1010. The activation function node 1010 may apply an activation function such as σ(•), for example. However, other forms of activation functions may be applied, including for instance a sigmoidal function, hyperbolic tangent and piecewise linear activation functions. The activation function may compress the amplitude of its input signal to a confined range such as [0,1] or [−1,1].

In one exemplary aspect, the output of the activation function may be an estimate of the squashed dot-product associated with the underlying continuous-time AN:

\hat{x}(t)=σ[\hat{y}(t)]. (45)

The squashed dot-product \hat{x}(t) may be passed to the APM encoder 1012. In turn, the APM encoder 1012 may convert \hat{x}(t) into a spike train s(t) that may be output from the APM neuron.

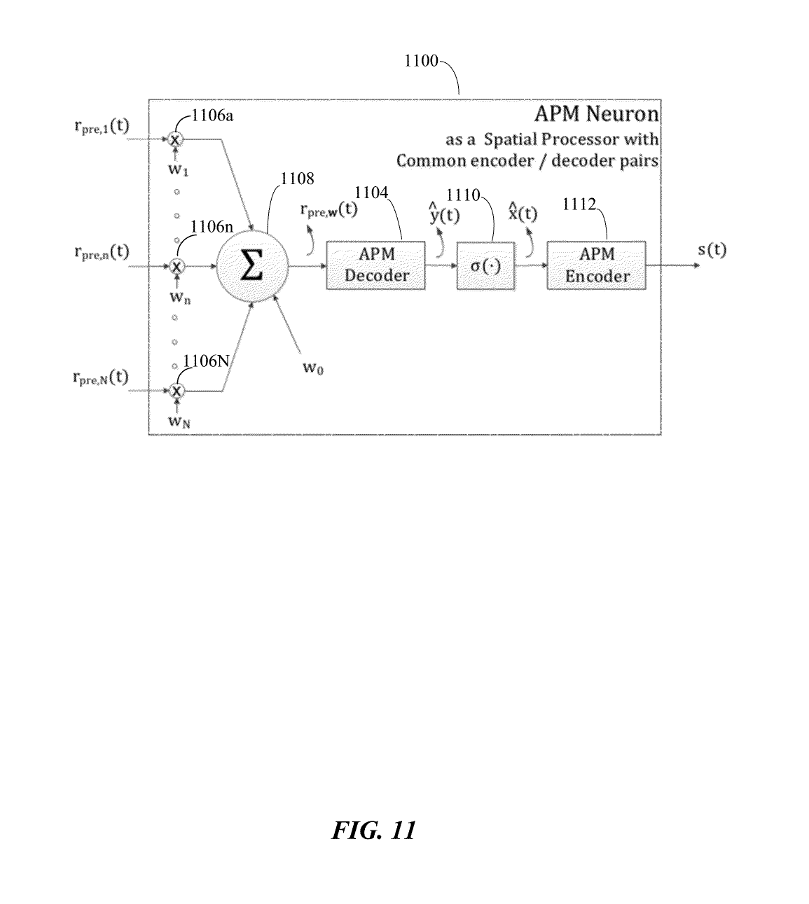

In some aspects, the APM neuron 1000 may be simplified when APM encoder/decoder pairs are common. For example, common APM decoders may be pooled into a single decoder. FIG. 11 is a block diagram illustrating an exemplary simplified APM neuron 1100. As shown in FIG. 11, a single APM decoder 1104 can be used in the case when all APM encoder and decoder pairs are identical or common. Each APM decoder (e.g., 1004a, 1004N of FIG. 10) may be commonly configured. The order of the synaptic weight multiplication operation and the APM decoder may also be reversed. As such, the nth received spike train may be scaled by the synaptic weight wₙ and then passed to the APM decoder 1104.

By linearity, the N APM decoders (shown in FIG. 10) may be consolidated into one decoder (1104) and moved to after the summation operation at the summing node 1108. Accordingly, each of the N weighted spike trains from the multipliers (e.g., 1106a, 1106N) may be summed to form the consolidated spike train:

r_{pre,w}=Σₙ₌₁^{N}wₙr_{pre,n}(t). (46)

The consolidated spike train r_{pre,w}(t) may be supplied to the APM decoder 1104 to generate ŷ(t) As before, ŷ(t) is passed through an activation function node 1110, which applies an activation function to generate the biased dot-product \hat{x}(t). The signal \hat{x}(t) may be provided to an APM encoder 1112 to generate an output spike train s(t).

Further simplifications may be realized. For example, in the absence of the activation function (e.g., σ(•)), the APM neuron may compute a biased dot-product (no squashing).

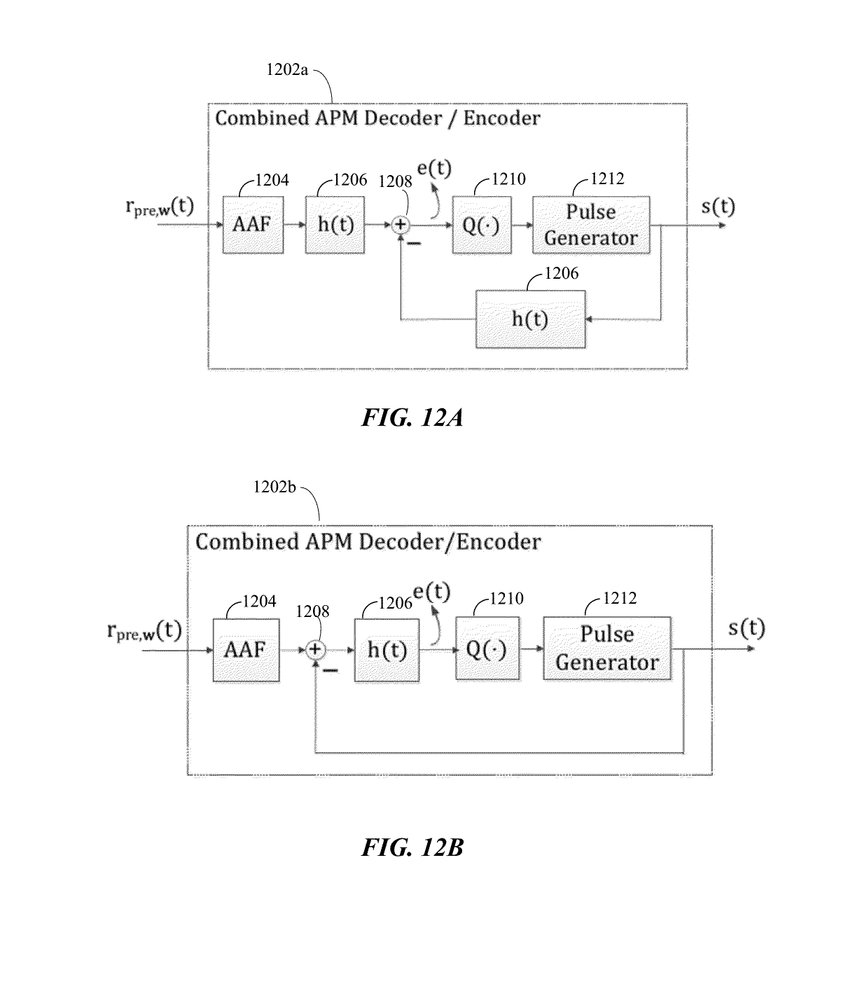

FIG. 12A is a block diagram illustrating signal processing blocks for a combined APM decoder/encoder 1202a in accordance with aspects of the present disclosure. The combined APM decoder/encoder may comprise a smoothing filter (e.g., anti-aliasing filter (AAF)) 1204 delta filters 1206, a summer 1208, a quantizer 1210, and a pulse generator 1212.

In some aspects, the signal processing block for the combined APM decoder/encoder may be simplified. FIG. 12B illustrates an exemplary simplified signal processing block 1202b. As shown in FIG. 12B, the two delta filters h(t) can be moved to after the subtraction operator and combined into a single h(t).

The combined APM decoder/encoder may comprise an asynchronous pulse sigma delta modulator (APSDM) preceded by a smoothing filter 1204 (e.g., AAF). As such the combined APM decoder/encoder block (e.g., 1202b) may take the aggregate r_{pre,w}(t) of the N weighted spike trains (shown in FIG. 11) and encode it into a non-weighted output spike train s(t).

### APM Neuron as a Space-Time Processor

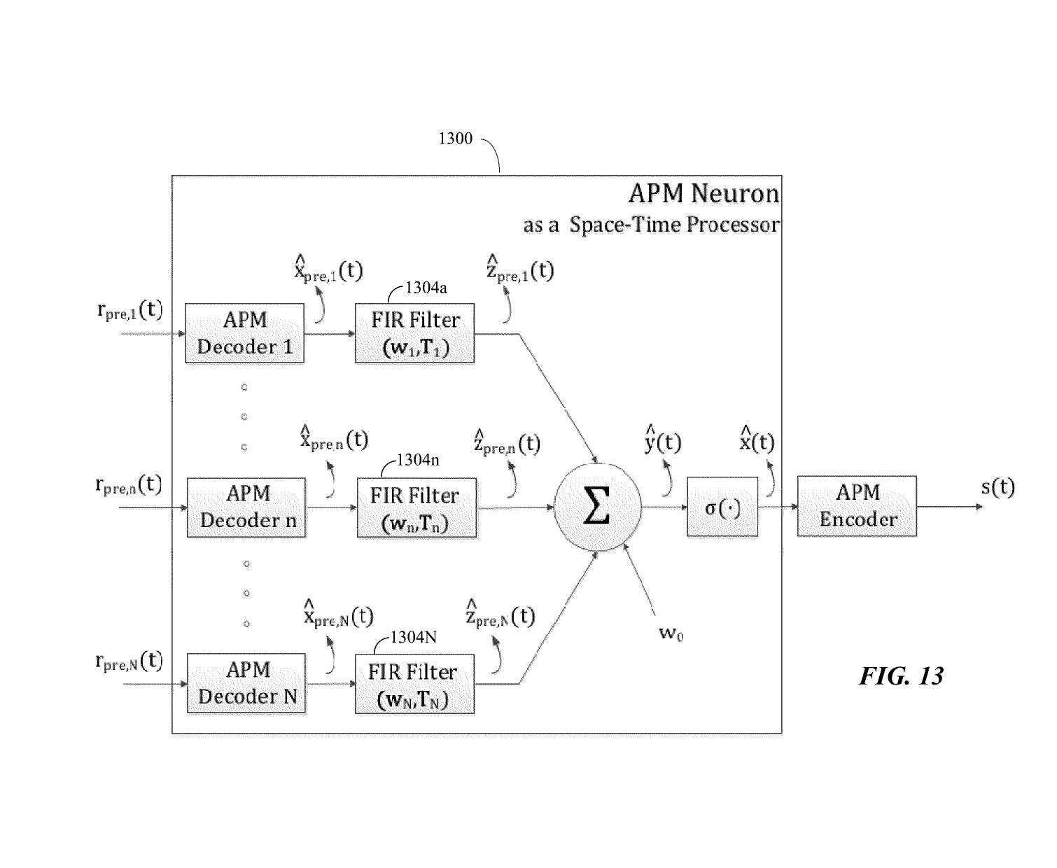

FIG. 13 is a block diagram illustrating an exemplary artificial neuron 1300 configured as a space-time (or spatial-temporal) processor in accordance with aspects of the present disclosure. Similar to the APM neuron 1000 of FIG. 10, the artificial neuron or APM neuron 1300 may be connected with N presynaptic neurons. However, multiple synapses may exist between a single presynaptic neuron and the APM neuron 1300.

There are N pairs of APM encoders and decoders where APM decoder n (shown) is matched to a presynaptic APM encoder n (not shown), where n=1, 2, . . . , N. The received spike train r_{pre,n}(t) from presynaptic neuron n is first provided to APM decoder n to generate a reconstructed estimate \hat{x}_{pre,n}(t) of the input signal x_{pre,n}(t) which was encoded by presynaptic APM encoder n. The input signal x_{pre,n}(t) may represent the squashed dot-product computed at presynaptic neuron n.

The estimate \hat{x}_{pre,n}(t) is supplied to the FIR filter (e.g., 1304a, 1304N) which generates the signal:

\hat{z}_{pre,n}(t)=Σⱼ₌₁^{L}^{ₙ}w_{n,j}\hat{x}_{pre,n}(t−T_{n,j}), (47)

where Lₙ≧1 represents the number of synapses (akin to the number of multipath channels) between the nth single presynaptic neuron and the APM (postsynaptic) neuron, w_{n,l}_{ₙ} represents the synaptic weight associated with the lₙth synapse where lₙ=1, 2, . . . , Lₙ and associated with the nth presynaptic neuron. Further, wₙ=[w_{n,1}, w_{n,2}, . . . , w_{n,L}_{ₙ}] represents a vector with Lₙ synaptic weights (akin to multipath channel tap weighs) associated with presynaptic neuron n, T_{n,l}_{ₙ}≧0 represents the time delay between the nth presynaptic neuron and the lₙth synapse where lₙ=1, 2, . . . , Lₙ and Tₙ=[T_{n,1}, T_{n,2}, . . . , T_{n,L}_{ₙ}] represents a vector with n delay elements associated with presynaptic neuron n.

The outputs of the FIR Filters are supplied to a summing node and summed with the bias term w₀, which yields an estimate of the biased dot-product:

\hat{y}(t)=w₀+Σₙ₌₁^{N}wₙ\hat{z}_{pre,n}(t). (48)

The biased dot-product estimate may, in turn, be passed to the activation function node which applies the activation function σ(t) to generate the squashed dot-product estimate:

\hat{x}(t)=σ[\hat{y}(t)], (49)

The squashed dot-product estimate provides an estimate in a time-varying manner of the similarity between a concatenated spatial signal vector and a concatenated spatial synaptic weight vector. The concatenated spatial signal vector may, for example, be defined as:

\hat{x}ₚᵣₑ(t)=[\hat{x}_{pre,1}(t), . . . , \hat{x}_{pre,N}(t)], (50)

where the spatial signal vector associated with presynaptic neuron n may be defined as:

\hat{x}_{pre,n}(t)=[\hat{x}_{pre,n}(t−T_{n,1}), . . . ,\hat{x}_{pre,n}(t−T_{n,L}_{ₙ})]. (51)

The concatenated spatial synaptic weight vector is w=[w₁, . . . , w_{N}], where the spatial signal vector associated with presynaptic neuron n is wₙ=[w_{n,1}, . . . , w_{n,L}_{ₙ}].

The squashed dot-product estimate \hat{x}(t) may be output and supplied to an APM encoder that converts \hat{x}(t) into a spike train s(t).

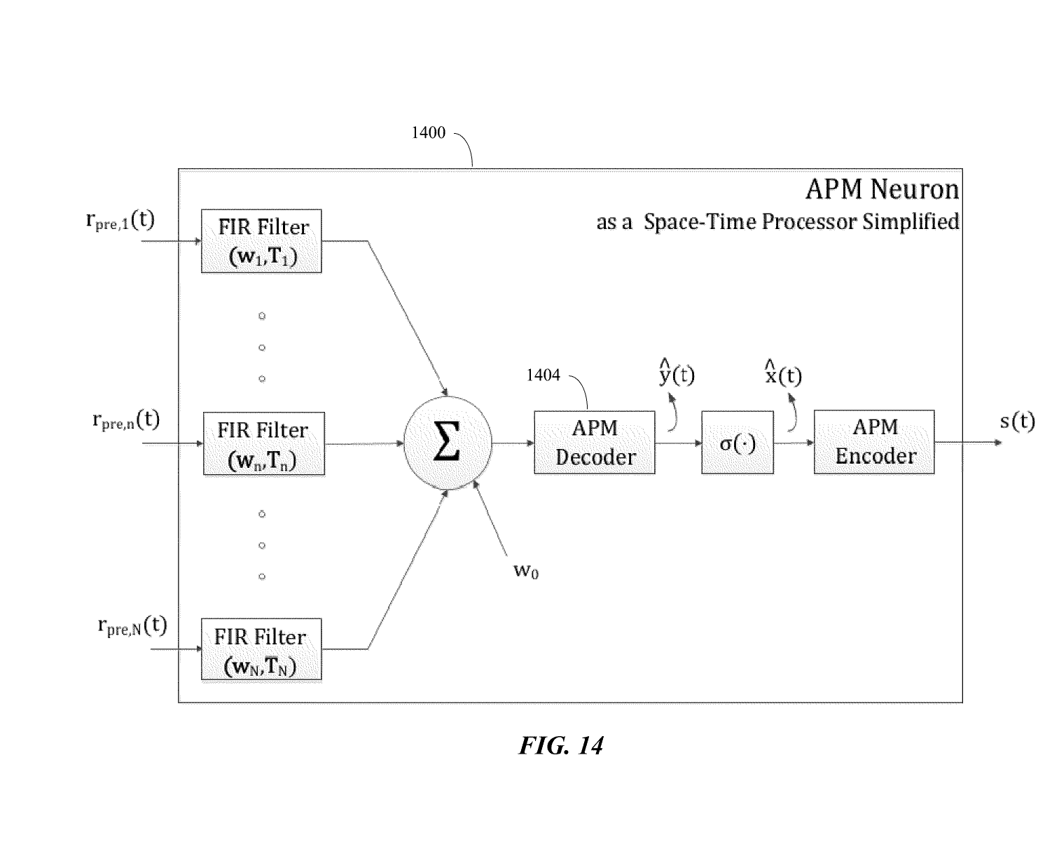

FIG. 14 is a block diagram illustrating an exemplary simplified space-time (spatial-temporal) APM neuron 1400. As shown in the example of FIG. 14, when APM encoder and decoder pairs are common, the APM neuron may be simplified in a manner similar to that described above with respect to FIGS. 11 and 12. Common APM decoders (shown in FIG. 13) may be pooled into a single decoder 1404.

Accordingly, when all APM encoder and decoder pairs are common or identical, the space-time APM neuron can be reduced. This may arise by switching the order of the FIR filters with the Decoders and then consolidating the N identical or common APM decoders into the single APM decoder 1404 after the summing node.

In some aspects, if the activation function is absent, then the APM decoder and encoder and therefore, the APM neuron may be further simplified as described above.

### APM Neuron as a Temporal Processor

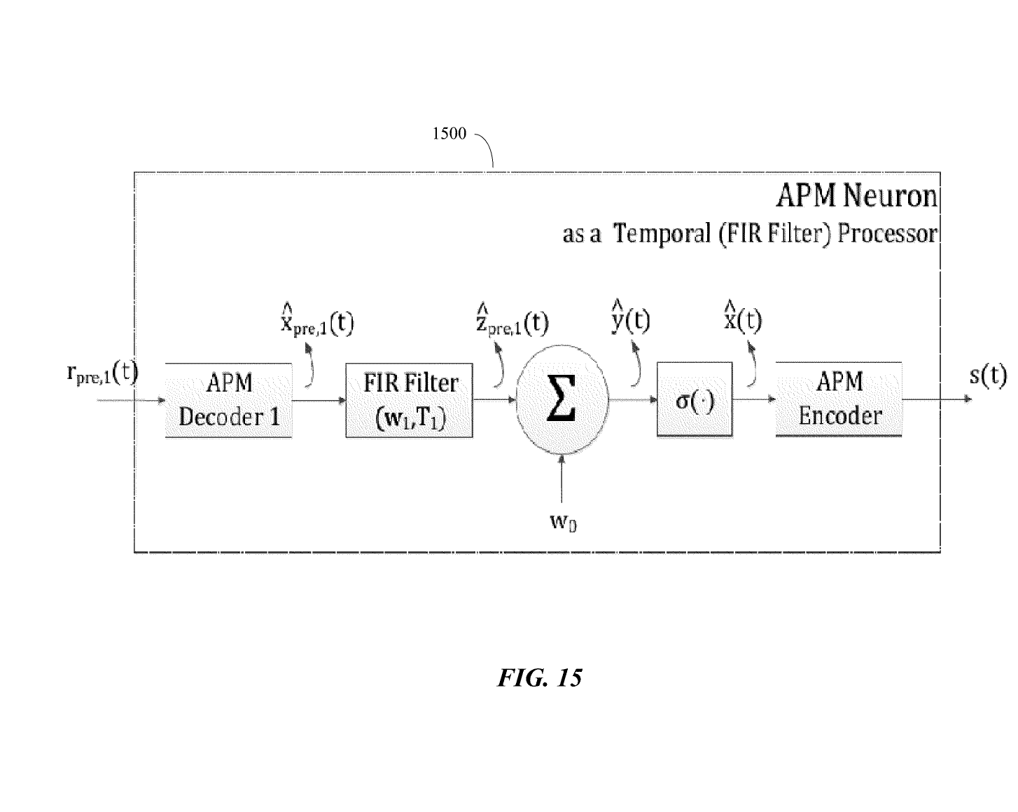

FIG. 15 is a block diagram illustrating an exemplary artificial neuron 1500 configured as a temporal processor in accordance with aspects of the present disclosure. As shown in FIG. 15, the temporal processor can be readily derived from the space-time processor described earlier with respect to FIG. 13, by setting the number of presynaptic neurons to N=1. In addition, simplifications arising when the encoder and decoder pairs are common and when the activation function is removed may be beneficially applied in the temporal processor as well.

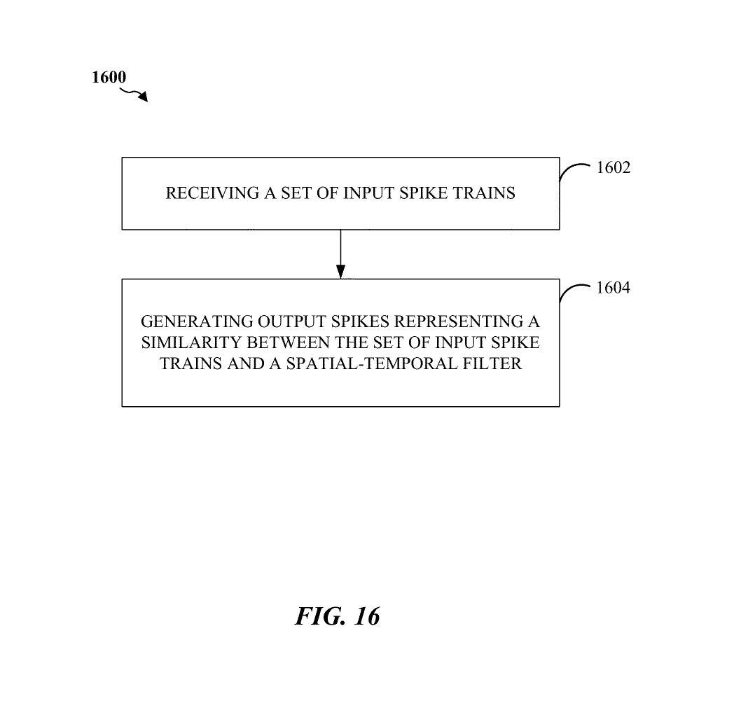

FIG. 16 illustrates a method 1600 for configuring an artificial neuron. In block 1602, the neuron model receives a set of input spike trains. The input spike trains may comprise an asynchronous pulse coding (e.g., APM, asynchronous delta modulation (ADM) or asynchronous sigma delta modulation (ASDM)) representation of prior continuous time input signals. For example, in some aspects, the input spike trains may include an asynchronous pulse coding representation of a prior continuous time input signal from a presynaptic neuron or from a sensory input source. In some aspects, the asynchronous pulse coding may be APM, ADM ASDM or the like.

In some aspects, the input spike trains may be supplied from a presynaptic neuron or a sensory input source, for example. The input spike trains may be sampled on an event basis. An event may be defined in many ways, including but not limited to, a pulse or spike, or packet transmission/reception. In one example, an event may be defined according to a pulse function or spike with a polarity of +ve or −ve (upside down) or w/different amplitudes. The time of the event may be implicitly encoded in accordance with the time that the pulse is generated and the source (pre-synaptic neuron) of the spike may be implicitly determined by a line or a synapse at which the spike appears.

In another example, an event may be defined according to an address event representation (AER) packet approach. In the AER packet approach, a time stamp may be explicitly encoded digitally (e.g., by a 16 bit value) and a source (pre-synaptic neuron) may also be explicitly encoded digitally (e.g., by a 16 bit address identifying the pre-synaptic neuron uniquely). Again, these approaches are merely exemplary and not limiting.

Furthermore, in block 1604, the neuron model generates output spikes representing a similarity between the set of input spike trains and a spatial-temporal filter. In some aspects, the similarity may be between the set of input spike trains and a spatial weight vector or with respect to a temporal filter.

The similarity may comprise a continuous time squashed dot product or a radial basis function.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described herein may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for configuring an artificial neuron, comprising:
receiving a set of input spike trains comprising asynchronous pulse modulation coding representations; and
generating output spikes representing a similarity between the set of input spike trains and a spatial-temporal filter.

2. The method of claim 1, in which the similarity comprises a continuous time squashed dot product or a radial basis function.

3. The method of claim 1, in which the input spike trains are sampled on an event-basis.

4. The method of claim 1, in which the artificial neuron comprises a Leaky-Integrate and Fire (LIF) neuron or a Spike Response Model (SRM) neuron.

5. The method of claim 1, in which the output spikes are unipolar, bipolar or multi-valued.

6. The method of claim 5, in which the bipolar output spikes are represented using Address Event Representation (AER) packets.

7. An apparatus for configuring an artificial neuron, comprising:
a memory; and
at least one processor coupled to the memory, the at least one processor being configured:
to receive a set of input spike trains comprising asynchronous pulse modulation coding representations; and
to generate output spikes representing a similarity between the set of input spike trains and a spatial-temporal filter.

8. The apparatus of claim 7, in which the similarity comprises a continuous time squashed dot product or a radial basis function.

9. The apparatus of claim 7, in which the at least one processor is further configured to sample the input spike trains on an event-basis.

10. The apparatus of claim 7, in which the artificial neuron comprises a Leaky-Integrate and Fire (LIF) neuron or a Spike Response Model (SRM) neuron.

11. The apparatus of claim 7, in which the at least one processor is further configured to generate output spikes that are unipolar, bipolar or multi-valued.

12. The apparatus of claim 11, in which the bipolar output spikes are represented using Address Event Representation (AER) packets.

13. An apparatus for configuring an artificial neuron, comprising:
means for receiving a set of input spike trains comprising asynchronous pulse modulation coding representations; and
means for generating output spikes representing a similarity between the set of input spike trains and a spatial-temporal filter.

14. The apparatus of claim 13, in which the similarity comprises a continuous time squashed dot product or a radial basis function.

15. The apparatus of claim 13, in which the input spike trains are sampled on an event-basis.

16. The apparatus of claim 13, in which the artificial neuron comprises a Leaky-Integrate and Fire (LIF) neuron or a Spike Response Model (SRM) neuron.

17. The apparatus of claim 13, in which the output spikes are unipolar, bipolar or multi-valued.

18. The apparatus of claim 17, in which the bipolar output spikes are represented using Address Event Representation (AER) packets.

19. A computer program product for configuring an artificial neuron, comprising:
a non-transitory computer readable medium having encoded thereon program code, the program code comprising:
program code to receive a set of input spike trains comprising asynchronous pulse modulation coding representations; and
program code to generate output spikes representing a similarity between the set of input spike trains and a spatial-temporal filter.

20. The computer program product of claim 19, in which the similarity comprises a continuous time squashed dot product or a radial basis function.

21. The computer program product of claim 19, further comprising program code to sample the input spike trains on an event-basis.

22. The computer program product of claim 19, in which the artificial neuron comprises a Leaky-Integrate and Fire (LIF) neuron or a Spike Response Model (SRM) neuron.

23. The computer program product of claim 19, further comprising program code to generate output spikes that are unipolar, bipolar or multi-valued.

24. The computer program product of claim 23, in which the bipolar output spikes are represented using Address Event Representation (AER) packets.
